(19) United States
(12) Patent Application Publication
(10) Pub. No.: US 2005/0229227 A1
(43) Pub. Date: Oct. 13, 2005

(54) Aggregation of retailers for televised media programming product placement

(75) Inventor: Brian Rogers, Minneapolis, MN (US)

Correspondence Address: ALTERA LAW GROUP, LLC, 6500 CITY WEST PARKWAY, SUITE 100, MINNEAPOLIS, MN, 55344-7704, US

(73) Assignee: Evenhere, Inc., Minneapolis, MN (US)

(21) Appl. No.: 10/962,793

(22) Filed: Oct. 12, 2004

Related U.S. Application Data
(60) Provisional application No. 60/562,020, filed on Apr. 13, 2004.

(51) Int. Cl. H04N 7/173; H04N 5/445; G06F 3/00; H04N 7/16

(52) U.S. Cl. 725/115; 725/93; 725/145; 725/60; 725/61

(57) ABSTRACT

For electronic commerce, selected items are tracked in a database and are made available for purchase by interactions with a customer. The construction and maintenance of the database may be summarized by three general steps. The first general step in the construction of the electronic commerce site is the establishment of a link between a particular product and a particular program or program episode that features the product. The second general step is creating a database of the records or links that are established from the first general step. The third general step is establishing an interface with the customer, which may be accomplished through the internet. A preferable technique for generating product tracking information uses radio frequency identification (RFID) tags to dynamically track products located in the video frame.

### CROSS-REFERENCE TO RELATED APPLICATIONS

This is a non-provisional application claiming the benefit of and priority to U.S. provisional patent application No. 60/562,020 filed on Apr. 13, 2004, which is incorporated by reference.

### STATEMENT REGARDING FEDERALLY SPONSORED RESEARCH OR DEVELOPMENT

Not Applicable

### BACKGROUND OF THE INVENTION

1. Field of the Invention

The present invention is directed to electronic commerce, and more particularly to tracking and purchasing items featured in the video frame of a television program.

2. Description of the Related Art

Since the inception of television, retail and consumer goods companies have been using the television medium to entice the consumer to purchase their goods. Methods have ranged from commercials, infomercials, and home shopping networks. All of these methods have successfully built strong brand recognition and customer loyalty, which has enticed the consumer to purchase their goods. But there hasn't been an effective selling channel to directly sell merchandise or consumer goods as seen on television program's talent or the program sets. An example of a direct selling to viewing interaction would be watching a TV program and then having the ability to purchase merchandise that was worn by the actor/announcer/sports figure or seen on the program's set. Through the introduction of electronic media available over the Internet on merchant e-commerce sites, the consumer has started to become more accustomed to a greater selection of selling channels and will begin to expect this kind of flexibility and ubiquitous access in all forms of electronic media, including television.

Direct marketing companies have attempted to fulfill the flexibility and ubiquitous access of e-commerce on the television through selling channels such as Television Home Shopping Channels.

Television Home Shopping Businesses (HSB) are part of a tightly dominated industry that markets products to consumers through exclusive 24-hour TV programming with accompanying e-commerce sites. HSBs market brand name merchandise and proprietary/private label consumer products using on-air personalities. Even though this approach to bridging the TV to Internet gap has been successful, it still does not give the consumer the flexibility he or she is used to when walking into a store or visiting websites. The HSB Industry has also not given merchants full sales potential because of costly and complicated partnerships required by the three companies that control the industry (ValueVision (ShopNBC.com), QVC Network, Inc, and Shop at Home, Inc).

A technology more adept to fulfilling the flexibility and ubiquitous access of electronic media is through Interactive Television (iTV). The iTV industry has evolved out of the new digital television technologies. The iTV electronic media selling channel approach allows a television viewer to select interactive buttons with his or her remote to activate events. These events can range from presenting the viewer an input box to enter his or her email address, an “additional information” page, or a direct connection to an ordering process which is processed through a company's e-commerce site (currently only used in commercials and not TV programming or movies). Interactive Television as a selling channel has encountered a slow consumer adoption rate due to technological and logistical barriers, such as the need for special digital TV set-top boxes, awkward input devices (remotes or keyboards), sometimes a completely new TV (depending on the digital TV provider), and the requirement of the viewer to subscribe to expensive digital TV services. Clickz.com recently estimated that iTV's commerce will be $2.1 billion by 2007, while in 2002 (through existing e-commerce sites on the Internet) sales peaked over $48 billion.

Technical limitations have prevented consumer goods companies from offering this type of direct access to their products advertised on television. Before digital television a provider of television programming could only offer a one-way form of media (motion picture images displayed on television sets). Conventional analog television broadcast provides a one-way broadcast of audiovisual information to a household's television set. This one-way broadcast passes non-compressed audiovisual information into individual channels over a very small pipe on the radio frequency bandwidth of 6 MHz. This pipe is just large enough to transmit the standard NTSC signal, which includes 525 lines of 720 pixels, for a total of 378,000 pixels per frame at 30 frames per second. Until now, technology has not been available to pass any more information across the airwaves to household television sets.

There was no way for a television viewer to interact with what he or she was viewing, such as selecting to buy or just learn more about the product being displayed in the television program. These limitations have also prohibited consumer goods companies from the ability to track the success of their television advertisement methodology.

Within the last few years, a two-way form of electronic media has been technically possible via digital television. The introduction of digital television has enabled broadcasters to squeeze five times as much information into the 6 MHz bandwidth. Digital television now allows a television programmer the ability to push motion picture images and additional data (related or unrelated to the programming). Furthermore, these advancements of digital television have enabled the viewer to interact with television programming by sending data back to the television network provider.

Digital television utilizes a process of passing information/data in a binary form (how computers communicate), which uses MPEG-2 compression capable of reducing the number of bits sent over the airwaves to a ratio of 55:1. This level of compression allows the broadcaster the flexibility to break each broadcast channel into a plurality of unique associated channels. The data stream available to each complete channel is 19.39 Mbps (Megabits per second).

Consequently, since the inception of digital television, the television network provider industry has been slow to adopt the full two-way capabilities of true digital television. Most television sets are not equipped to process the binary data from the digital broadcast, therefore another device will need to be connected to the television set. This device is called the set-top box, which captures and processes the data sent over the airwaves or through coaxial cable. Because the set-top box has been engineered to capture and process digital data it can also communicate with personal computers (PCs) via radio frequency or direct cable connections. The set-top box can operate on commercially available PC operating systems, like Microsoft (MS) Windows, MS Windows CE, Java based systems, etc. The set-top box can also attach to telephone line or other means of out-going communication (i.e. cable modem, DSL, or satellite), which allows the viewer to communicate back to the broadcaster.

Further delays in adoption have been in part due to demanding network provider infrastructure requirements and the large number of television sets, in households, unable to receive and send data without additional hardware adapters (additional hardware referred to as set-top boxes). However, as cable and satellite companies begin to build out the required infrastructure a multitude of applications will enhance the quality of televised program material.

The ability for the broadcaster to pass additional audio and visual data introduces new functionality like interactive content, which can be associated with the broadcast program. Interactive Television (iTV) is currently offered through commercial providers such as MSN TV (formally WebTV) and Opentv. ITV, using solutions provided by MSN TV or Opentv, presents the user with content associated with specific broadcast television. Examples of associated content could be, for instance, a stats window on specific cars in a NASCAR race. In some iTV cases, the viewer has limited interactivity. For example, television commercials displayed on Opentv will present the viewer with an input box to enter an email address to request more information from the manufacturer showcased in the commercial. A viewer may also be able to select an item to purchase. Most of the viewer interactive input is performed via a remote control, which clearly has its limitations compared to a keyboard for a PC.

None of the current iTV providers, utilizing digital television, have been able to directly associate specific tracked moving televised objects and provide interactivity. Passively identifying and tracking televised objects, however, has been around since the 1970s. Sportvision, Inc. was the first to pioneer this technology by enhancing the video signal to highlight and track the puck in a NHL televised game. For the first time a viewer was given a visual guide to the location of the rapidly moving puck. The one thing that is missing in this current embodiment is the ability to actively associate content with each identified and tracked object.

There are many existing embodiments of the technology to identify and track a moving televised object. One embodiment consists of complicated methodologies such as mapping three dimensional planes with lasers and conforming the data back into a two dimensional environment which can be translated into a computer for superimposing over a video feed frame-by-frame. This embodiment requires the use of complex devices, which are attached to camera lens to measure the tilt, zoom, pan, and gravity changes. Another embodiment of this technology requires specially separating the identified moving object by utilizing differences in light characteristics, such as painting the object with a substance with a reflective characteristic different than other non-painted objects or impregnating the object with an infrared sensor. All of the existing embodiments of the technologies for identifying and tracking moving televised objects are one-way presentations of information. Neither the broadcaster nor viewer can select the object being identified and tracked for additional information.

The present invention makes possible first the foundation of data and the interactivity of digital television making products placed in televised programming accessible to the consumer. One embodiment of the present invention captures and presents products from an aggregate of merchants onto an Internet web site. A further embodiment of the present invention will identify and track moving televised objects utilizing a more simplistic methodology that relies on RFID, associating information in a two-way fashion (on the tracked objects) that will give greater depth of information, and provide a two-way ITV platform capable of associating with an e-commerce website or additional interactive pages on the television (i.e. shopping, customer input, etc.)

### BRIEF SUMMARY OF THE INVENTION

An embodiment is a method of maintaining a media database, comprising the steps: selecting a plurality of video programs designated by a content provider as having products placed therein for possible purchase; selecting a subset of such products from the group of placed products associated with the selected programs; creating a database of the product subset; associating the product subset with product description information; associating the product subset with product purchase information; generating a web page on the internet accessible by a user that associates the product subset with a product merchant; and allowing the user to select a video program by name and view the product subset for the program so that a user may easily locate and purchase products shown on the selected program.

A further embodiment is a method of dynamically identifying the location of a purchasable object in a field of a video program, comprising: creating a database of products placed in the video field; providing a video signal, wherein the video signal displays the object on screen for a length of time; generating dynamic position information in response to the location of the object on screen; synchronizing the dynamic position information to the video signal to form a linkable data annotation to the video signal which identifies the product and its variable location on the screen; and transmitting the annotated data and video signal to viewers.

A further embodiment is a method of purchasing an object, comprising: selecting an object for purchase; establishing a plurality of boundary RFID tags to define the periphery of an active region; placing an RFID tag on the object, each tag capable of having a unique identifier; using an RFID reader to determine the locations of the object and the boundary RFID tags; tracking the location of the object while it is inside the active region to establish a location signal with location information encoded therein; calculating a two-dimensional position signal, the position signal corresponding to the location of the object in the video frame; synchronizing a video signal recorded by the video camera to the two-dimensional position signal to form an annotated video signal; transmitting the annotated video signal to a user terminal; establishing a media database having product data linked to specified identifiers; performing a query from the user terminal to the media database to retrieve information about the object, the information including a representative icon and a web link to a vendor that sells the object; displaying an icon corresponding to the object at the edge of the screen during the length of time in which the object is tracked within the active region; and providing means for the user to select at least one icon and transmitting such selection to a second database of items selected for purchase for review.

A further embodiment is a method of identifying an object featured on a set of a pre-recorded television program, comprising: establishing a plurality of beacon RFID tags; placing the plurality of beacon RFID tags at a plurality of substantially stationary beacon locations on the set of the television program, prior to recording of the program; establishing at least one object RFID tag; attaching the at least one object RFID tag to the object; placing the object on the set of the television program during recording of the program; using an RFID reader to record the relative locations of the plurality of the beacon RFID tags and the at least one object RFID tag, so that any movement of the object within the set during recording of the television program may be tracked; establishing a time code representing a time index of the recording; synchronizing the recorded location of the at least one object RFID tag with the time code; generating a media file representing the combination of the at least one RFID tag location with respect to the time code; downloading the media file to a set top box; processing the media file with the set top box, so that when the television program is transmitted to the set top box, the set top box displays an icon on the screen whenever the object appears in the video frame.

A further embodiment is a method of processing a media file containing object location information synchronized with a time code, comprising: receiving the media file by a set top box; selecting an icon corresponding to a product displayed on the screen by the set top box; and bookmarking the product, the bookmarking comprising: generating an identification file containing viewer information, program information and information about the selected product; sending the identification file to a central system, the central system having an accessible website; accessing the website of the central system; and receiving a personalized message on the website, the personalized message having the information contained in the identification file including the viewer information, the program information and information about the selected product.

A further embodiment is a method of processing a media file containing object location information synchronized with a time code, comprising: receiving the media file by a set top box; selecting an icon corresponding to a product displayed on the screen by the set top box during the viewing of a video program; and purchasing the product, the purchasing comprising: entering payment and shipment information into an interface screen delivered through the set top box.

A further embodiment is a system for purchasing a product featured on a video program, comprising: a plurality of video programs, each video program having a video field; a plurality of products for purchase, each product being linked to at least one program, the products being displayed for at least some time in the video field, each link also connecting a product to a source of supply for purchase; a searchable database comprising a plurality of said links; an encoder which tracks the dynamic location of a product in the video field to establish a two-dimensional location signal, and which synchronizes the two-dimensional location signal to the database to form product tracking information; a transmitter which transmits both the video program simultaneous with the product tracking information to the customer; a decoder which receives the transmitted video program and the product tracking information, the decoder displaying the video program on a television and displaying indicia corresponding to the product displayed on the television during the duration of time that the product appears in the video field; and a user-selectable controller which allows the user to select specific indicia corresponding to products that the user may wish to purchase.

### BRIEF DESCRIPTION OF THE SEVERAL VIEWS OF THE DRAWINGS

FIG. 1 is a block diagram detailing the global process flow of the present invention's two components: Web Storefront/internet system aggregation of merchants and the setup of objects to be electronically tracked and displayed on digital television networks.

FIG. 2 is a block diagram of the present invention's global process flow of the Web Storefront System.

FIG. 3 is a block diagram of a retailer's product data exchange through its e-commerce site.

FIG. 4 is an example of the merchant data feed XML file that would be pasted to load into the Master Media Database.

FIG. 5 is a block diagram of the merchant product data feed file to the FTP.

FIG. 6 is a block diagram of the data load from merchant product and XMLTV data feeds into the Master Media Database.

FIG. 7 is a block diagram of a general operational flow within the Administration Tool.

FIG. 8 is a general screen mock-up of the Administration Tool.

FIG. 9 is an additional general screen mock-up of the Administration Tool.

FIG. 10 is an additional general screen mock-up of the Administration Tool.

FIG. 11 is a block diagram of the online store flow.

FIG. 12 is an exemplary web screen mock-up of a customers navigation on the invention's electronic commerce site.

FIG. 13 is a further exemplary web screen mock-up of a customer's navigation on the invention's electronic commerce site.

FIG. 14 is a further exemplary web screen mock-up of a customer's navigation on the invention's electronic commerce site.

FIG. 15 is a further exemplary web screen mock-up of a customer's navigation on the invention's electronic commerce site.

FIG. 16 is a further exemplary web screen mock-up of a customer's navigation on the invention's electronic commerce site.

FIG. 17 is a block diagram of the Session Page Rendering Architecture.

FIG. 18 is a block diagram the User Session.

FIG. 19 is an illustration of placing RFID tags on objects for triangulating their local positions and synchronization with recorded television footage.

FIG. 20 is an illustration of the UPC and RFID ePC.

FIG. 21 is an illustration of creating the set boundaries for activating or deactivating RFID tags.

FIG. 22 is an illustration of visualizing tracked and associated objects in a televised program.

FIG. 23 is a web home page mock-up of a personalized bookmark from a televised program.

FIG. 24 is an illustration of a pop-up window for purchase on a television set.

### DETAILED DESCRIPTION OF THE INVENTION

In broad terms, the present embodiment is directed toward to electronic commerce, in which selected items are tracked in a database and are made available for purchase by interactions with a user or customer. The construction and maintenance of the database may be summarized by three general steps, detailed below. The purchasing process is summarized in the third step as well.

The first general step is the establishment of a link between a particular product and a particular program or program episode that features the product. This is typically done by a representative at the program's production company, who generates a record detailing which products are featured in which episodes.

As an example, consider a wardrobe designer for a television program that routinely works with a particular retailer to choose items that are worn by the program's characters. Typically, the wardrobe designer selects items of clothing in the proper sizes from the retailer, then checks out, producing a list of items. The list may be in electronic form, and may or may not include prices, identification numbers such as SKU numbers, and item descriptions. Alternatively, a typical list may be on paper, and may be printed from the retailer, or may be handwritten, and may or may not contain any of the above information.

For the construction of the electronic commerce database, the costume designer and retailer may keep a slightly more detailed list than during typical operation. For instance, if the costume designer needs a red sweater for a particular episode of a program, the list may include indicia about the retailer's red sweater, such as an ID or SKU number, and may include information about the program and the particular episode in which the red sweater is worn. Preferably, the costume designer tracks enough information to link the red sweater to a particular episode of a program.

As another example, a particular cooking show may feature a particular style of pots and pans, used during multiple episodes. The pans may be purchased or bartered through a particular retailer, or may be furnished to the program by a retailer or manufacturer as a promotional tool. In accordance with the first general step outlined above, information is provided to the owner of the database that identifies the particular manufacturer and style of pots and pans, a retailer through which one may purchase the pots and pans, and the particular episode(s) in which the pots and pans are used. Note that pots and pans may be used during multiple episodes, whereas particular food ingredients may show up in only one episode. Note also that multiple retailers may be identified from which to purchase the pots and pans.

As a very detailed example, consider a pair of boots, worn by a particular actor in a particular episode of a TV series. Typically the men's costume designer for the program was responsible for obtaining the boots, and presumably did so in an arrangement with a stylish local retailer. In accordance with the present embodiment, specifically the first general step mentioned above, the designer would record enough information to link the specific style of boots to the particular episode. He would note a SKU number, a particular identifying code used by the retailer, or perhaps the boot manufacturer and style. He would also note the episode title, the episode broadcast date, or perhaps an internal code used by the show's production company or the network identifying the particular episode. His record may be kept electronically, or on paper or some other well-known storage device. Alternatively, the record may be kept by the retailer, the production company, the owner of the database, or another entity. Although the specific aspects of the record-keeping may vary from those described here, at the end of the general first step for our example, there is a record generated that links the actor's specific boots to the episode, and indicates a retailer from which the boots may be purchased.

The second general step in the construction of the electronic commerce site is creating a database of the records or links that are established from the first general step. Preferably, the database includes as many items as possible from as many shows as possible that air on as many channels as possible. Ideally, the database becomes a hub for general product placement on television, and includes virtually anything that may appear on camera during a program, such as appliances, furniture, clothing, food, cars, tools, and so on. Because the database links products, the retailers that sell them, and the programs that feature them, such a database is of immense value to the program providers, who may receive a commission on sales generated through the database.

The database may be searchable using various criteria. For instance, one may search by network, by calendar or airtime schedule, by program or category of program (say, home improvement shows), by category of item (say, tools), by item (say, which programs feature a particular cordless drill), by retailer, or by other criteria as well. The database preferably links customers to external retailers without conducting sales of its own. Alternatively, the owners of the database may choose to sell some products and conduct some transactions directly through the database, rather than directing customers exclusively to external retailers.

The third general step in the construction of the electronic commerce site is establishing an interface with the customer. In a first embodiment, a customer accesses a central website via the internet, which contains all of searching and linking functions that are required to locate an item for purchase, then direct the customer to the website of the appropriate retailer to complete the transaction. The central website has access to the database produced by the second general step, and may perform searches according to various criteria, described above. The central website may additionally perform some purchasing functions, such as storing of personal information or credit card numbers, for example.

Retuming to the very specific example of the boots, a customer using the central website may search for the boots using a number of different criteria. The customer may search for all products featured on that episode of that series and may pick the boots off a list of all products featured on all episodes of the show. Or, the customer may search for all products featured on the specific episode and may pick the boots off a list of all products featured on that particular episode. Or, the customer may search for a category of products, such as boots or shoes, and select the boots off a list of all boots or shoes featured on all shows. The search algorithms and categories are well known in the field of databases, and may include search fields and categories not specified here. In addition, the display of individual products and categories may include images as well as text, as well as links to appropriate retailers (say, shoe vendors).

In a second embodiment of the third general step, the interface with the customer may be through a decoder attached to (or embedded in) the customer's television. Before a show is aired, an encoder system recognizes the presence of one or more selected items or products in the frame during a program, and may preferably track the items' locations on screen as the program is recorded. The encoder system then synchronizes the location information to the database produced by the second general step, and stores the synchronized location information as product tracking information. During broadcast, the product tracking information is received at a home decoder (preferably as digital information) along with the program itself, and the decoder displays some indicia of any of the selected products appearing on screen at the time that they appear on screen. The decoder may preferably be integrated into the customer's television, or may be a separate device. The customer may respond to the indicia on the screen using the television's remote control, or a separate controller. When an index is selected, the customer may be directed toward an interactive system, in which text and images of the product may be displayed, and where the product may be purchased.

Continuing with the boots, a customer with the appropriate decoder watching the episode sees a particular index on the screen whenever the boots appear on camera. The index may be a small image of the boots in a portion of the screen, or possibly a number or color corresponding to the boots, or an icon or graphic representation of the boots. When the actor wearing the boots walks off camera, the index preferably disappears, although it may be made accessible for a period of time afterward by an additional index that may provide a history of indicia that were missed the first time around. The index may be selectable by a number on the remote control, or by a combination of keys, such as arrow keys. If the index is selected, the customer is directed to an interactive panel on the screen, from which the customer may purchase the boots. In addition, multiple products may be present on the screen simultaneously, such as a necklace. Each product is preferably denoted by its own index on the screen.

In this second embodiment, any number of schemes may be used to produce the product tracking information. A preferable technique uses radio frequency identification (RFID) tags or other equipment presently in existence or later developed to transmit or transpond ID data (or perform pattern recognition to identify objects without ID tags), and is described in further detail below. Other techniques may be used as well, including image recognition, as well as manual encoding by hand.

The following paragraphs describe the preferred embodiment in a great deal more detail, with appropriate figures. In the description that follows, the present invention is explained in reference to embodiments that operate on a client-server network using HTTP, XML, HTML, and other commonly used computer software application interface (API) development standards. The network can be an intranet, an extranet, the Internet, or a digital cable broadcast. The present invention is explained here as two systematic components: Web Storefront (WSI) and Television Interface.

The system and method of the present invention will provide television viewers a gateway between a retailer's e-commerce website and products placed in television programs (e.g. primetime sitcoms, sporting events, music videos, etc.). The system provides two possible embodiments for the purchase of products as seen on specific televised events. In the first embodiment a user is able to search a web storefront on the Internet, which is disparate of the television broadcast. The second embodiment provides the user real-time or near real-time identification of products as they appear on the televised broadcast's characters or production sets. In this second embodiment the user is able to select an item for purchase, as it is being broadcast to the television set. In both embodiments, once the user either locates or identifies the item placed in the specific episode, the system of the present invention will refer the user directly to a product detail page on the merchant's electronic commerce (e-commerce) website.

In an exemplary embodiment of the present invention retailers will be able to directly reference their products down to the specific aired show (i.e. specific episode of a situational comedy). For instance, a user had been watching an episode of his favorite situational comedy (sitcom) and liked the design of a wine glass, which one of the show's characters' was drinking from. Utilizing the system and method of the present invention, the viewer would be able to look up the specific episode of the sitcom from the present invention's web Storefront, select and purchase the wine glass as seen in the episode.

Every page on the System's web Storefront will employ a common Internet software structure known as hypertext markup language (HTML), which is transferred to the user using a protocol known as hypertext transfer protocol (HTTP). A user will first access or invoke these HTML pages using an application program known as a browser. A popular browser is Microsoft's Internet Explorer. The user will need to locate (through a multitude of methods such Search Engines or on other web sites) or enter the System's universal resource locator (URL) address into his or her browser. A customer will also be able to access the web Storefront using a wireless application protocol (WAP) browser as well. Once on the web Storefront, the user will be able to navigate, or link, from page-to-page by clicking on HTML text, which is then interpreted by the user's browser.

In the second embodiment, the wine glass will be identified by a graphic drawn on the screen that references a small product image in the footer of the screen. In this embodiment, the content provider will be simultaneously capturing video footage frame-by-frame and capturing location and product information from Radio Frequency Identification (RFID) tags placed on objects being filmed (i.e. clothing on actors and set props). Video footage and product data will then be synchronized and placed into a file to be broadcast to households with digital cable.

Up until now there has not been a viable method for a television viewer or web shopper to purchase an item as seen on television program on a specific date.

The descriptions of the Web Storefront and Television Interface are intended to be illustrative. This invention is susceptible of embodiment in many different forms that is shown in the drawings and will herein be described in detail specific embodiments, with the understanding that the present disclosure is to be considered as exemplary of principles of the invention and not intended to limit the invention to the specific embodiments shown and described. In the description below, like references numerals are used to describe the same, similar or corresponding parts in the several views of the drawings. Additionally, the systems and methods architecture described in the present disclosure allows for easy adaptation to other display platforms including digital set-top, satellite decoders, video game consoles and wireless applications (WAP). The two components of the present invention will be herein collectively referred to as the System.

The following figures will begin with a global overview of the entire system and methodology of the present invention. Each figure thereafter will continue to go into more detail of each of the System's embodiments.

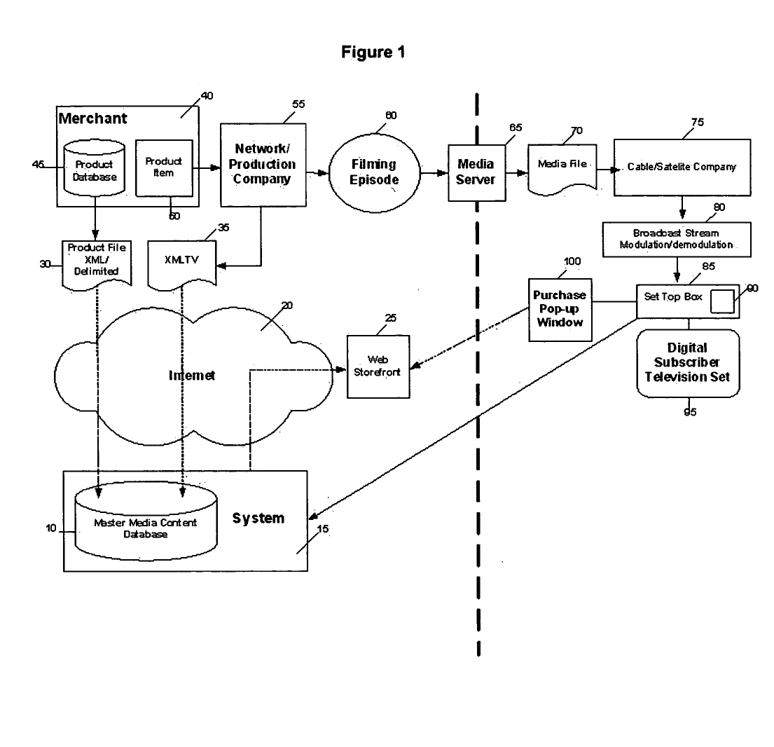

FIG. 1 shows the global process flow of the present invention. The method and system of the present invention allows users to identify still or in-motion objects as they appear in televised programming. Furthermore, the user is able to purchase the objects, as seen in near or real-time within the television program from a multitude of merchants through the invention's single Web Storefront Interface 25 accessible over the Internet 20 and through a Television Interface 100 accessible through a digital subscriber television set 95.

The Web Storefront System is rooted at the Master Media Content Database (MMCD) 10 wherein all product and televised programming data is loaded and processed for user presentation. The MMCD receives product data on a nightly basis from product data files, herein referred to as the Merchant Product File (MPF) 30, which the merchant 40 extracts from its product database 45. Using a similar methodology, the MMCD also retrieves televised programming data from Media Production Companies 55 in an industry standard XML format 50 (commonly used for digital video recorders such as TiVo).

A Media Production Company 55 can select any item from any merchant for placement on a television show that has established a successful MPF load to the MMCD. Once a merchant's MPF is in the MMCD a writer, for example, of a popular television program can asked the wardrobe designer to select a casual summer dress from one of the included merchants for a specific episode to be produced. The wardrobe designer goes out to the local retail store of the specific merchant and finds the right casual summer dress. At this point in the System, the exact style or stock keeping unit (SKU) can be associated with a television network and the specific episode in which it will appear.

The second systematic component of the present invention involves digitally capturing record of objects being filmed on the production set. After the selection of the object (casual summer dress) as stated above, the wardrobe designer will fit the actor in it and begin filming 60. The present invention employs a common identification technology known as Radio Frequency Identification (RFID) tags. The RFID tags wirelessly transmit product and location data to the Media Server 65 so that the objects placed in the filmed scene can be synchronized with footage captured by the camera. After both footage (captured by the camera) and RFID data captured from the specific objects on the set, the Media Server creates the Program Media File (PMF). The PMF is passed to the front-end of a Digital Cable or Satellite Company 75 for modulation and demodulation 80, which includes it into the broadcast stream. Once in the broadcast stream, a subscriber of a digital network will be able to process the PMF through a device connected to the television set known as a set-top box 85. The set-top box interprets the PMF for presentation on the television set. If required, the set-top box saves the PMF to a storage device 90 so that it can be processed locally on the set-top box's internal processor (storage devices are typically included in most set-top boxes.

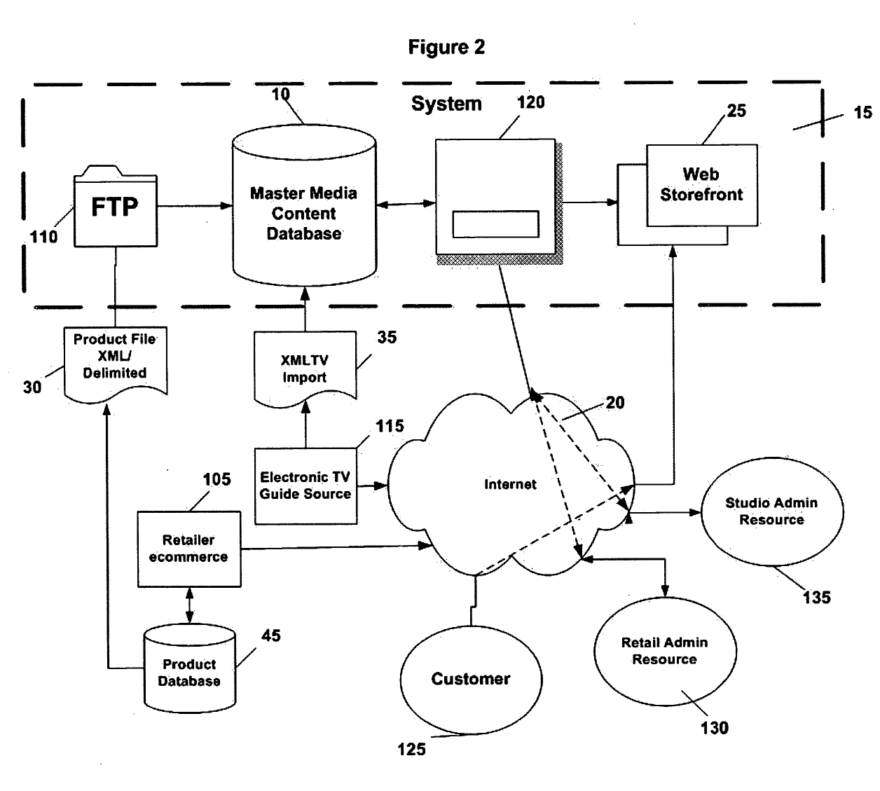

We now describe the method and system of the Web Storefront Interface shown in FIG. 2. The Web Storefront Interface will herein be referred to as the System 15. As stated in FIG. 1, the System's methodology first relies on the Merchant Product File (MPF) 30 from a merchant's e-commerce website's product catalog database 45. The System will then require a process to be run on a scheduled basis that will extract all or specific product data from the retailer's database. The scheduled data extraction event will place the product data into an XML/delimited file normalized to the System's specification. In the preferred embodiment of the System, XML is the file format. The MPF will then be pushed to the System's File Transfer Protocol (FTP) site 110. Once MPF has successfully been pushed to the FTP site, the System will run a scheduled event, which will pull it off and process it (process will be further defined in subsequerit drawings included). After the MPF is successfully processed by the System, it will be loaded into the System's Master Media Content Database (MMCD) 10.

In addition to the loading of the MPF, the preferred embodiment of the System will also require the import of a XML file 35 from media sources 115 containing television programming data. This television data XML file will be herein referred to as the XMLTV Import 35. The XMLTV Import will be essential for the MMCD 10 to associate merchant product information with specific television programming content.

Once the MPF and XMLTV Import have successfully loaded into the System's MMCD, the System will be able to begin instantiating the data. The first instantiation of data will be to associate product data to a specific media partner through a graphical user interface (GUI) Internet web based tool 120. This GUI web based tool will herein be referred to as the Admin Tool 120. After the product data has been associated to the specific media partner the resulting media to retailer association can be pushed to the System's web pages 25.

The System's web pages will be accessible via the Internet 20 to the customer 125, merchant administrative resources 130, and studio administrative resources 135.

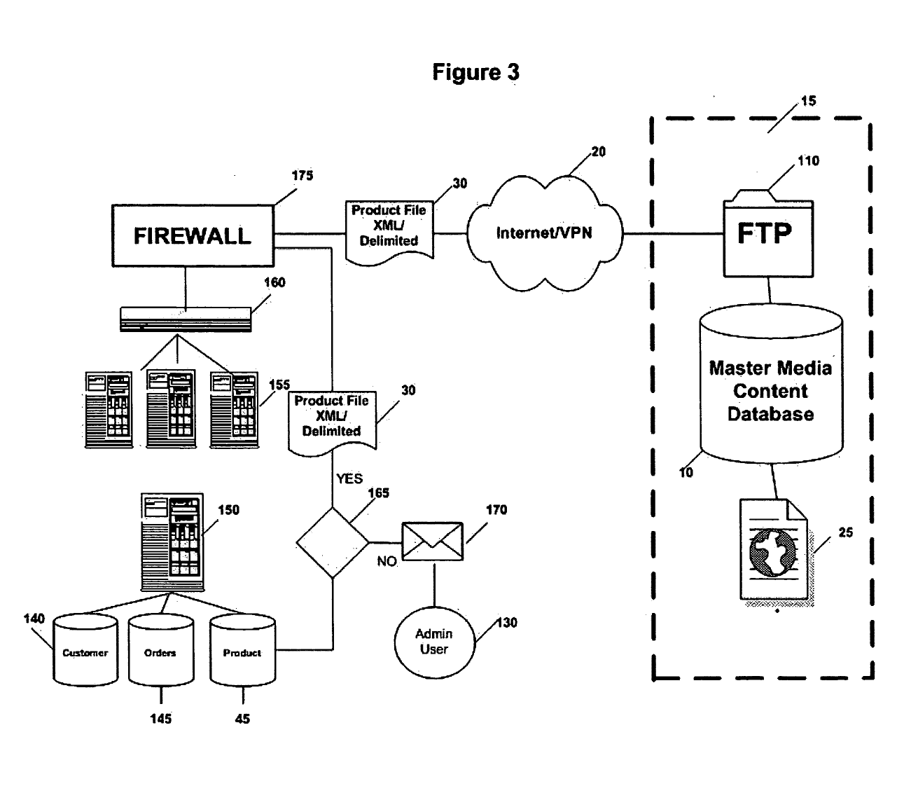

In an embodiment of the System, the Merchant Product File (MPF) must be created and flow through multiple steps before loading into the System. A merchant is required to have an e-commerce infrastructure as an initial step to accommodate the creation and ongoing process of the MPF. The following is a high level description of a typical architecture of an e-commerce infrastructure, therefore the architectural comments below are not meant to be a complete operational description of an e-commerce infrastructure. See FIG. 3. The type of hardware and software is selected to conform to the data processing requirements of the system, but is otherwise a matter of choice, it important to understand both environments from a high level in the context of the present invention.

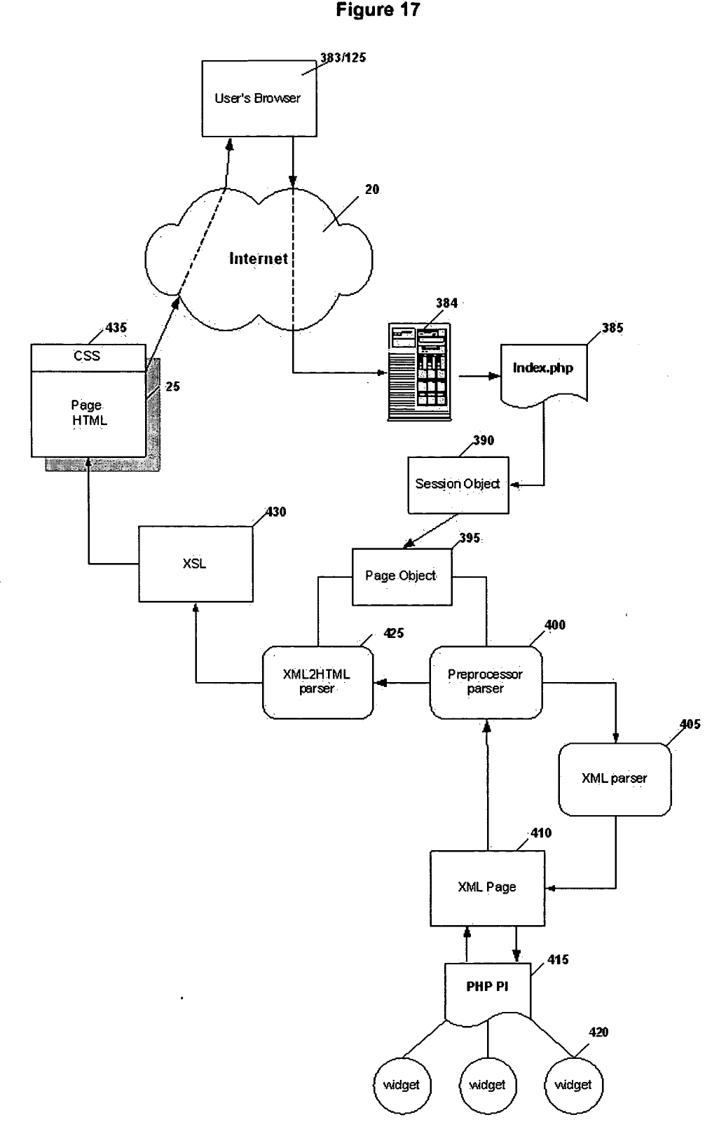

An e-commerce infrastructure requires a retailer to take its existing product information and organize it into a digital format that will be organized into multiple relational databases. The databases are the building blocks that allow the merchant's product information to be organized and placed into a format to be published on the Internet through HTTP messaging protocol. A typical e-commerce database includes, but is not limited to, Customer data 140, Orders 145, and Product data 45. The database structure and relationships will enable the retailer the flexibility to organize catalog and product information into a coherent hierarchy with a depth definable by the merchant. The databases are then in turn controlled by an Application Server 150. The Application Server acts as a device that manages the relational events between the databases. An example of such an event is a query to the Product database after a customer identifies an item of interest, as displayed graphically on the web page. The customer will click on a graphic or text that is hyperlinked. The graphic or text hyperlink elicits a request for additional information or files. The request occurs through the web based communications application protocol Hypertext Transfer Protocol (HTTP). HTTP message protocol runs off the top of the TCP/IP suite of protocols (foundation protocols of the Internet) which allows web elements to be linked with one another. Once the product's hypertext link is clicked, an event occurs which will query the Product database for the associating product information. In the example above, in order for the customer to be able to view the product and click it, the e-commerce infrastructure requires a web server(s)
155. The web server(s) 155 acts as the device that manages the presentation events of content on pages viewable on the Internet to the customer. These pages contain content in the Internet standard HTTP message protocol format Hypertext Markup Language (HTML). In the example above, hence after the correct product information is queried it will then be placed into HTML and presented on pages which will then be viewable to users of the Internet (a more in-depth explanation of the System's use of these technologies will be covered in FIG. 17 “Page Rendering Architecture”).

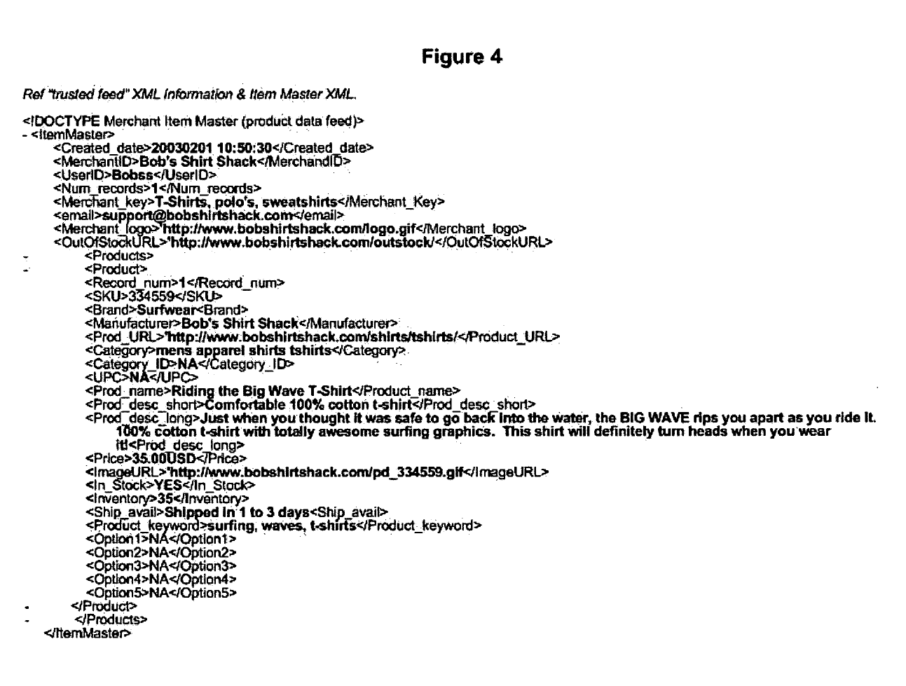

In a specific embodiment the MPF is formed by receiving a Document Type Definition (DTD) as an instruction set on the required data for the creation of the XML document to be processed through the System (FIG. 4 is an example of an MPF with one item). In the preferred embodiment the merchant builds a scheduled event that pulls all of the required data from the Product Database 45 on the Application Server 150 into the MPF 30. In the preferred embodiment after the scheduled event runs successfully, the retailer will run the MPF through a format validation script 100. If the format validation fails an administrative retail 110 user will receive email notification of errors 105.

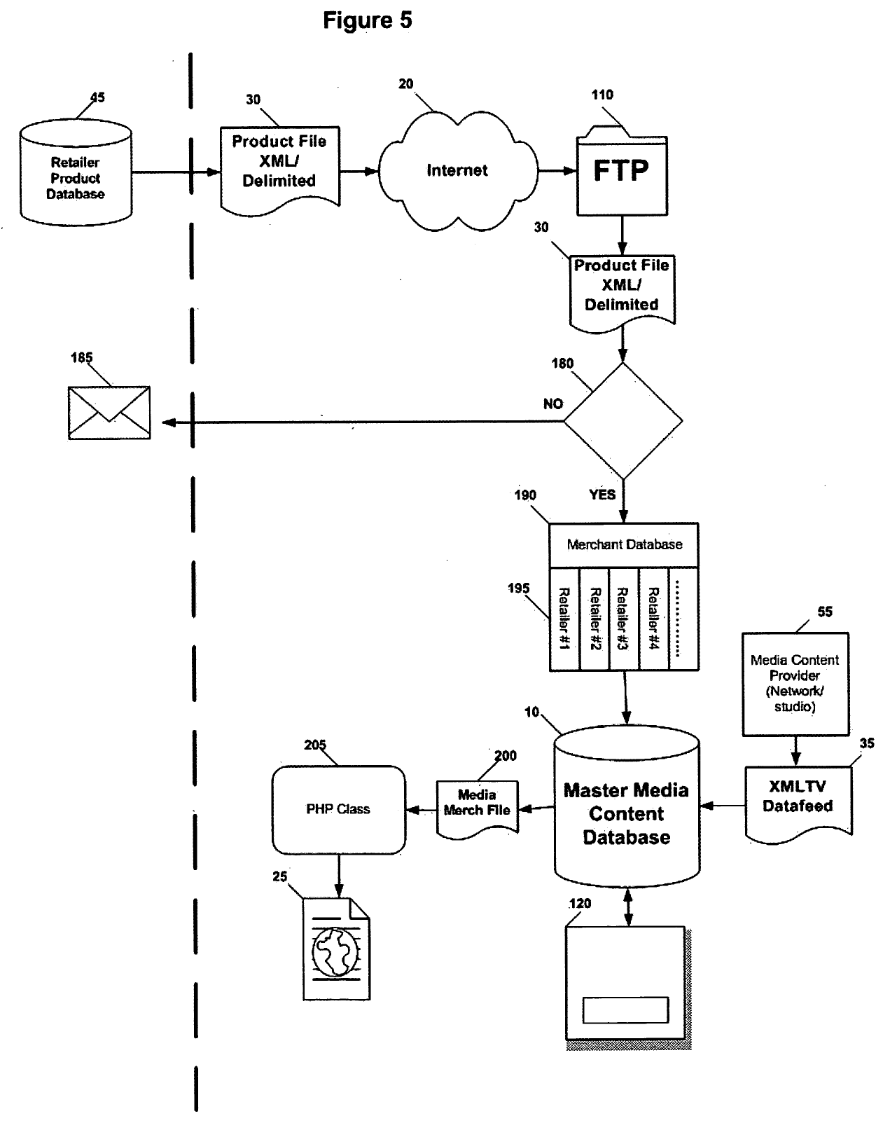

Once the validation is successful a complete MPF is created 20. After the formation of a complete and proper MPF, the MPF will be passed through the retailer's firewall 130. Once outside the firewall, a mover script will push the MPF over the Internet or an Intranet 60 (whichever is the preferred network) to an FTP site 25. Another mover script on the System side will then pull the retailer's MPF off the FTP and load it into the respective System's data tables in the Master Media Database 30 (explained in greater detail in FIG. 5 Merchant Product Feed to Master Media Database). After the MPF has successfully loaded and an association with the appropriate media has occurred, the data can be pushed to the System's web pages 25 for user browsing.

In the preferred embodiment the MPF will be an XML document. FIG. 4 is an example of an XML document MPF containing one item. The XML document will consist of required Header and Item level detail records. In the preferred embodiment the required Header XML element will herein be referred to as <ItemMaster> (not limited to). In the preferred embodiment the Item detail will herein be referred to as <Product>.

The <ItemMaster> of the MPF is designated for differentiating MPF specific to each retailer. The <ItemMaster> will include, but not limited to; created date, merchant identification, identification of the merchant user, number of records in the file (number of items), merchant keywords, email address, and Universal Resource Locator (URL) address to the company's logo.

The <Product> of the MPF is designated for providing item level data required by the System. The <Product> will include, but not limited to; record number of each listed item (reference key required for the System), the item brand name, manufacturer, item URL, category(s) the item lives in, category identification, Universal Product Code (UPC) or Electronic Product Code (ePC), item name, short product description, long product description, price of specific item, item image URL, inventory status, items in inventory, shipment availability, product keywords, and multiple optional data fields for customization.

Referring to FIG. 5, in an embodiment of the present invention once the Merchant Product File (MPF) 30 has been created from the merchant's database 45 it is then posted to the System's FTP 110 site via the Internet or Intranet 20. System will pull the MPF 30 off the FTP and pass it through a file format validation process 180. The validation process ensures, but is not limited to, that each required and optional field from the merchant MPF is properly formatted and reliable (product and image URL works). The process will also validate that the merchant's specific requirements with the System are met. If the MPF passes the validation, it is loaded in the MMCD 10 and a confirmation of a valid upload will be triggered. If the any of the validation MPF components fail, the MPF will not load into the MMCD and an email notification 185 will be triggered and sent to the merchant detailing the errors.

Once the MPF passes the validation process it posts to respective retailer tables in the System Merchant Database (SMD) 190. The Merchant Database breaks out merchant data into distinct tables 195 by referencing data from the header segment <ItemMaster> (seen in FIG. 4) of the MPF. After the unique retailer data is posted to its respective tables, it is then associated with television programming data from the XMLTV file 35 (received from Media Content Providers 55). Both the MPF and XMLTV data are associated in the MMCD 10. After the television programming and the retailer product data is associated in the MMCD, the retailer will be able to make the product to television program/episode association which will be presented on the System's web pages 25. The association of the product and program/episode that is presented in the System's web pages is established through the Admin Tool 120. The web pages are rendered through programs based off a scripting language referred to as php classes 205 (explained further in FIG. 17 “Session Page Rendering Architecture”).

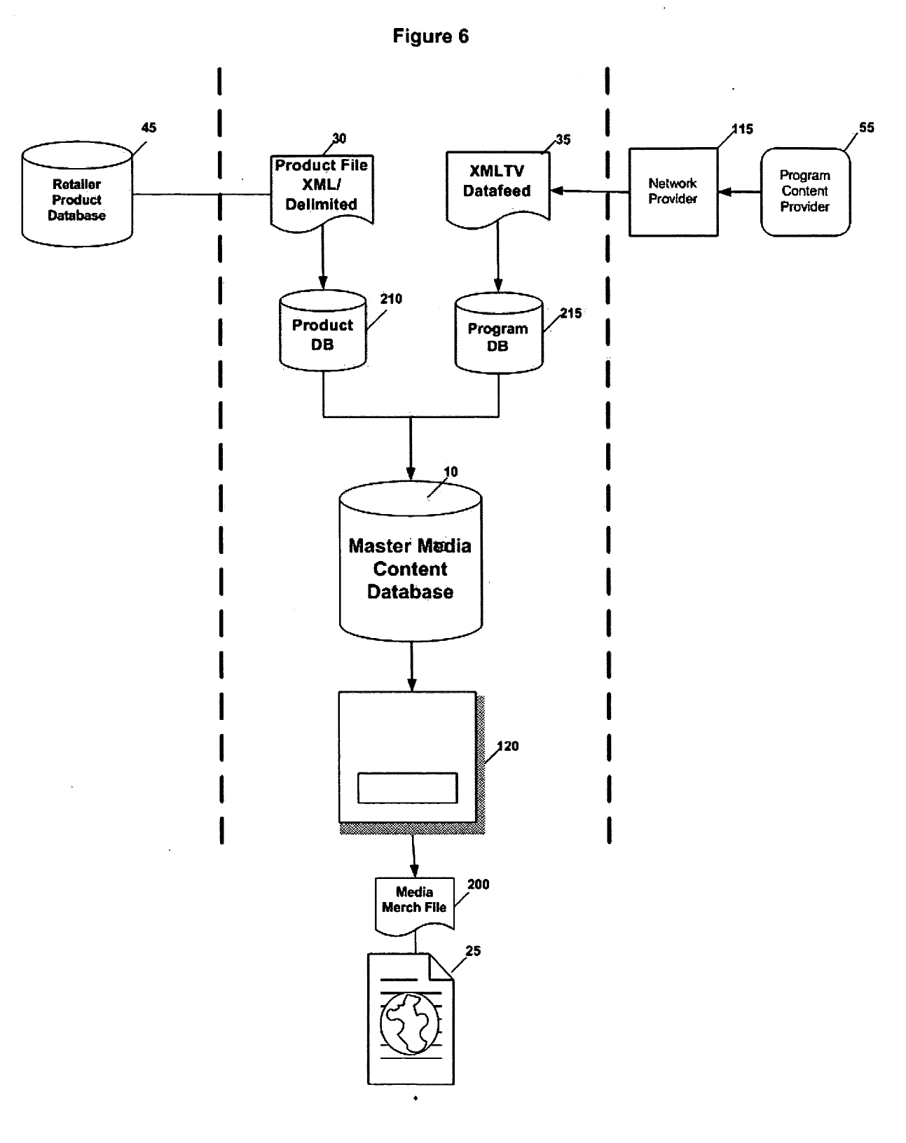

Referring to FIG. 6, in the preferred embodiment the Television Programming data of all televised content (regular television, cable, and satellite programming) is aggregated 35 in an XML format from the Program Content Provider 55 known here as the XMLTV Data feed 35. The aggregation of the televised content serves as a mechanism to allow program navigation on the System's web pages and to relate televised content stored in the System's Program Database 215 with products stored in the System's product database 210 (retrieved from the merchant's product data feed 30). The present invention is not limited to the type of television content delivery, (XMLTV) described here. XMLTV is selected as the preferred intermediary format for the television content delivery to conform to the data processing requirements of the System, but is otherwise a matter of choice.

In the specific embodiment the XMLTV Data Feed 35 will contain program specific data such as: episode number, time of airing, cast, director, etc. (not limited to). The XMLTV Data File is posted to the System's Program Database 215. In the preferred embodiment, the Network Database will contain program specific tables linking to extended program information databases. Relationships between products, from the System's product catalog tables 210, and televised content are created by associating the product_id of a product with a progam_id of a televised program. The association is created through an abstraction interface or user enabled administration tool 120, which stores the association in the MMCD 10. After a relationship and association of a product to a televised program is completed, a file defining this association is created. This file will be herein referred to as the Media Merchant File (MMF) 200. The MMF will thus be the basis for the System's creation of web pages 25 for specific products published to the Web Storefront to specific televised programs.

This process is not limited to television program data. The added level of indirection offered by the abstraction interface allows one to relate products to any type of program datum including music videos, movies, and other programming such as commercials.

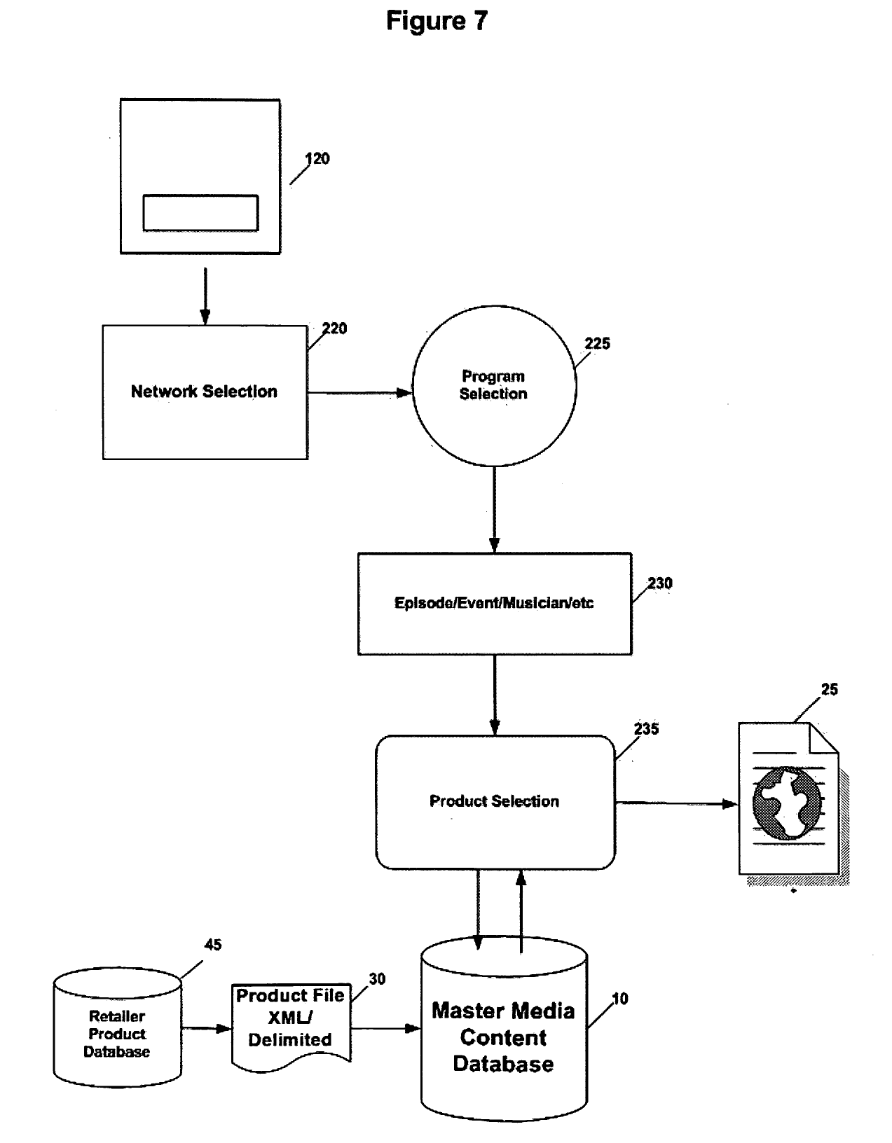

An embodiment of the System will include a content authoring functionality. The content authoring module of the system will be herein referred to as the Admin Tool. FIG. 7 is a block diagram of a data flow within the Admin Tool (not limited to the following detail).

A user will administer content changes in the System through a series of web enabled pages 120 accessible via the Internet or Intranets (not limited to other network connections). The web enabled administration pages will navigate the user through the setup and association of retailer products and television programming. The first level of navigation begins by selecting a Network/other media content provider 220 (i.e. NBC or MTV). Once a network/content provider has been selected the user will navigate to a display of all programming available, as designated by the content provider as a program with product placement 225. In the preferred embodiment of the present invention, the administrative user responsible for content changes and associations will be performed by a representative of the merchant. The Admin Tool will have username and password access unique to each merchant. This differentiating level of merchant's access to the Admin Tool will push a navigation that will be unique to the merchant. Hence, only the programs deemed by the network/media content provider as programming with merchant product placement partnerships will appear in the retailer's access to the Admin Tool.

After a program 225 has been selected, the user will be presented with a list of available episodes/individual broadcast event 230. Each episode/program will be displayed by date of airing. The admin user can then select an episode/broadcast event. Once a broadcast event is selected the user will query a product 235, from the MMCD 10, to associate with the broadcast event. The user will be able to perform specific or broad searches to locate the exact product item to associate with the broadcast event. The product data will be current to the retailer's last MPF feed 30 from the merchant's product database 45 as detailed in FIG. 5. After all product items have been successfully queried and associated with the broadcast event, all product items will be posted to the MMCD 10 and pushed to the web pages 25.

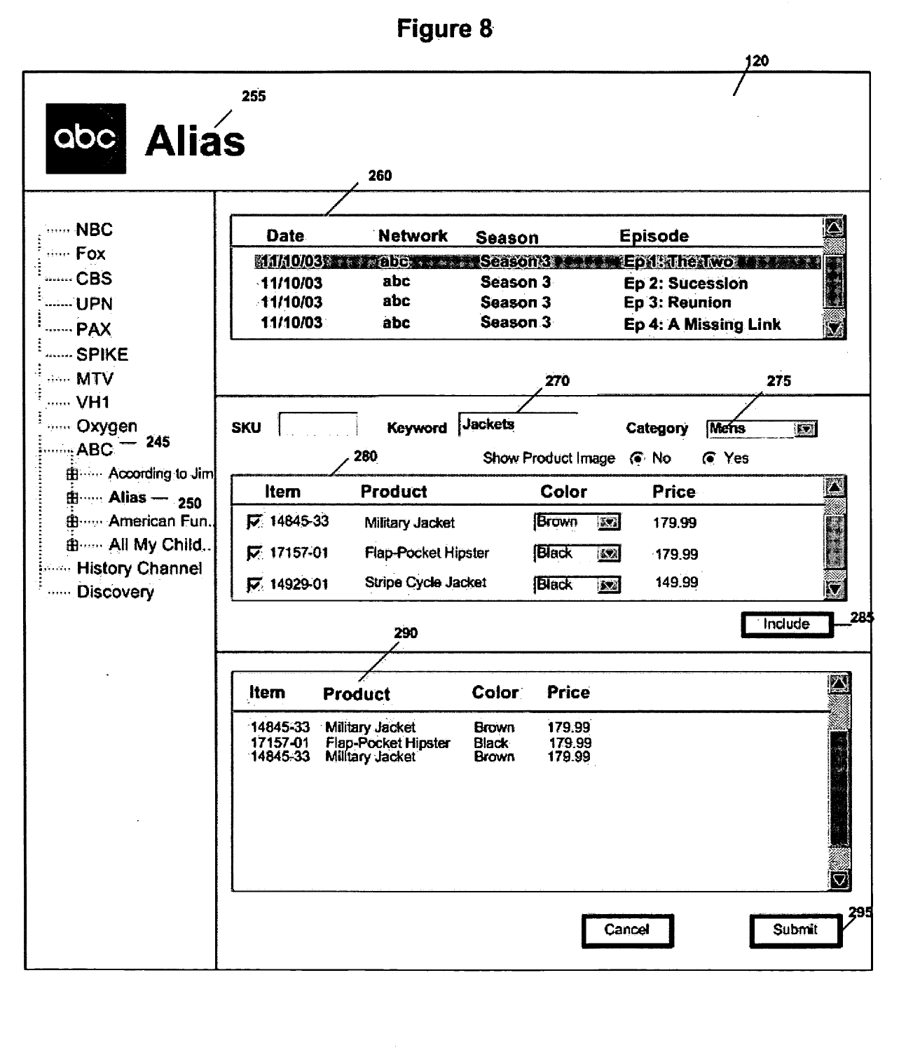

FIG. 8 is an illustrative example of a possible mock-up of the System's web enabled Admin Tool page 120. In the following example the merchant administrative user queries products (as loaded from the MPF 30) to associate to specific available television programming (retailer will not be able to select television programs which have not been previously setup/designated by the appropriate approval process defined by the television program owner).

The first illustrative step in the System is to administer the record and association of product(s) placed in a specific television program, which involves selecting the television network 245. Selecting the television network will expand a tree structure of available shows. In the specific embodiment of this illustration the administrator selects, for instance, the television show “Alias” 250. Selecting the television show “Alias” will populate a form template 255 (specific to “Alias” and the Merchant) and initiate a call to the Master Media Content Database (MMCD) for the corresponding show data (show data received from the XMLTV Data feed 35 in FIG. 6). In this illustration the show's corresponding data are the individual episodes by date of airing 260. The administrator will select the episode “The Two” in which products from its retail company will be displayed (furniture on the set, character wardrobe, etc.).

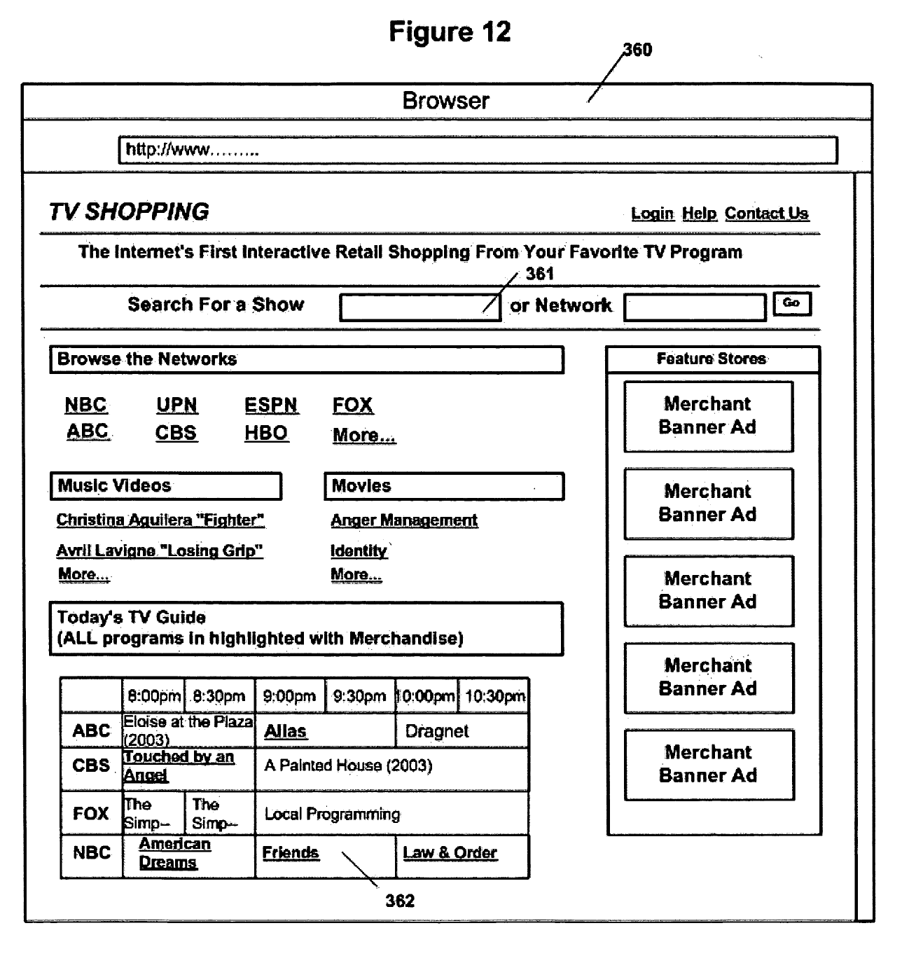

Once the network and specific television program are selected, the administrator will query the MMCD for products from the retailer's product database. Multiple search methodologies 265 will be available to increase the accuracy and speed of locating the specific items required for placement in the specific episode. For illustrative purposes, some possible options are: by the products' SKU number, keyword association, and the category the product may live in. In the specific embodiment of the illustration of the present invention, the administrator uses the keyword search methodology inputting “jackets” 270 and the category “Men's” 275. By selecting the keyword “jackets” and the category “Men's” a display box in the television program “Alias” form template will display all of the retailer's available jackets in the Men's category. In the specific illustration of the System the administrator selects all three available jackets 280 and posts them to be associated with the program's specific episode 260. Once selected, all three products will appear in a final display box on the “Alias” form template 290. If the selection is accurate and complete, the administrator clicks the “submit” button 295 which will post the three jackets to the System's web pages for the specific “Alias” episode “The Two” (more detail on the web page presentation will be illustrated in FIGS. 12 through 16).

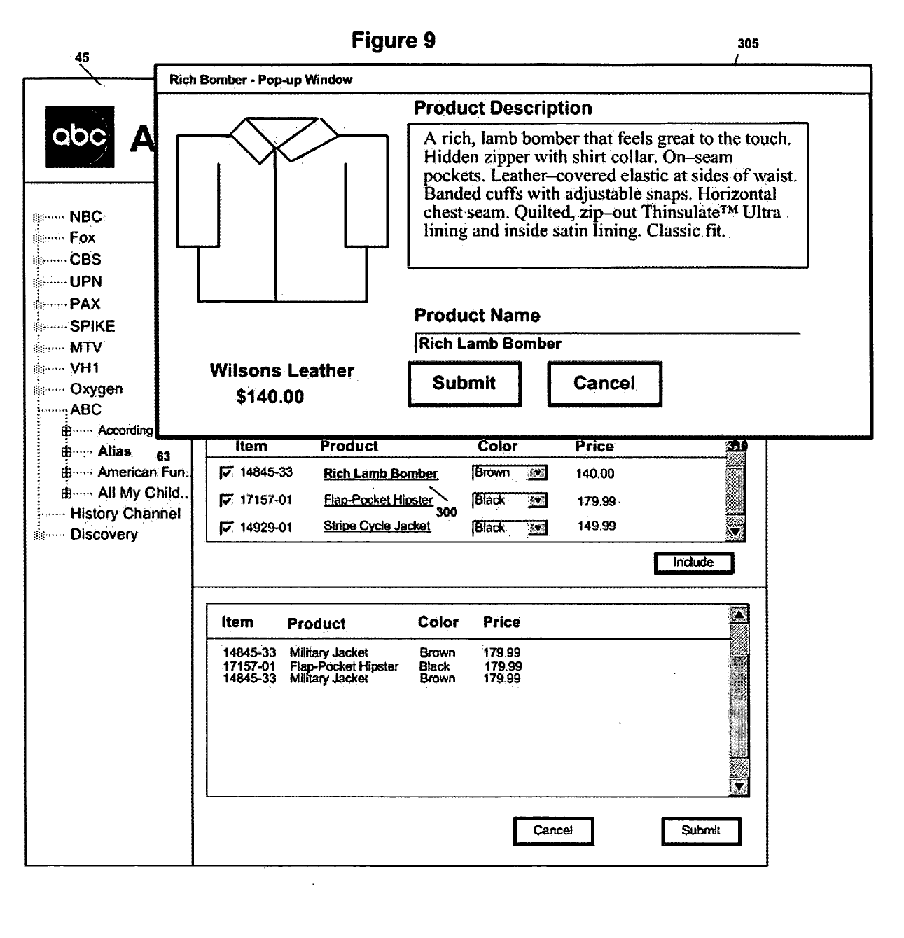

The administrator will have the option to change the product's description by clicking on the product name 300, seen in FIG. 9, in the product list box 280, seen in FIG. 8. In the specific embodiment of this illustration the administrator clicks the “Rich Lamb Bomber” 300. Once the administrator clicks the product's name a pop-up window 305 will appear with input boxes to change content specific to the displayed product. A merchant or studio Admin resource may want to change the product copy to include reference to the program episode. In the specific embodiment of this illustration the product's name and description are editable. The product's name and description will be pre-populated from the retailer contained within the MPF 20. After making the appropriate changes, the administrator can submit the changes, which in turn will update the MMCD 30. Content changes to specific products in the System's Admin Tool 45 will override any future content data elements for this specific product in the subsequent MPF.

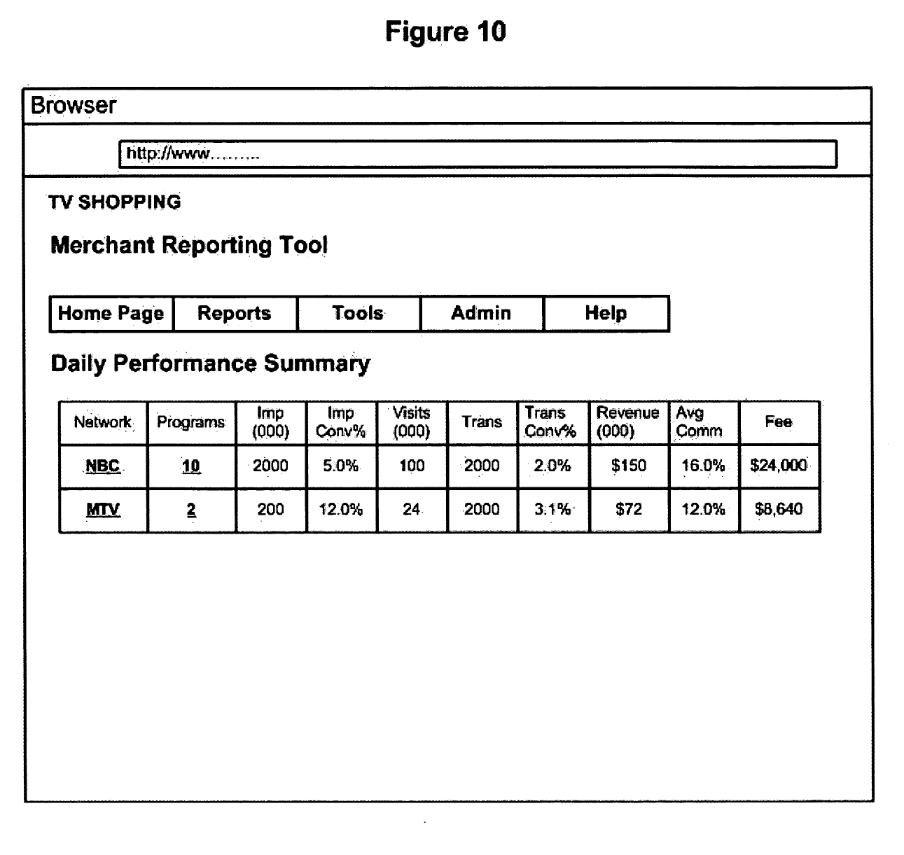

In addition to administering the inclusion of product for the Online Storefront, the Admin Tool will also provide the merchant and program content provider reporting FIG. 10. Reports will display the web user session statistics and revenue performance of each Network, program, category, and item (not limited to). The Reporting Tool is accessed via user name and password and presents data only specific to the merchant or content provider.

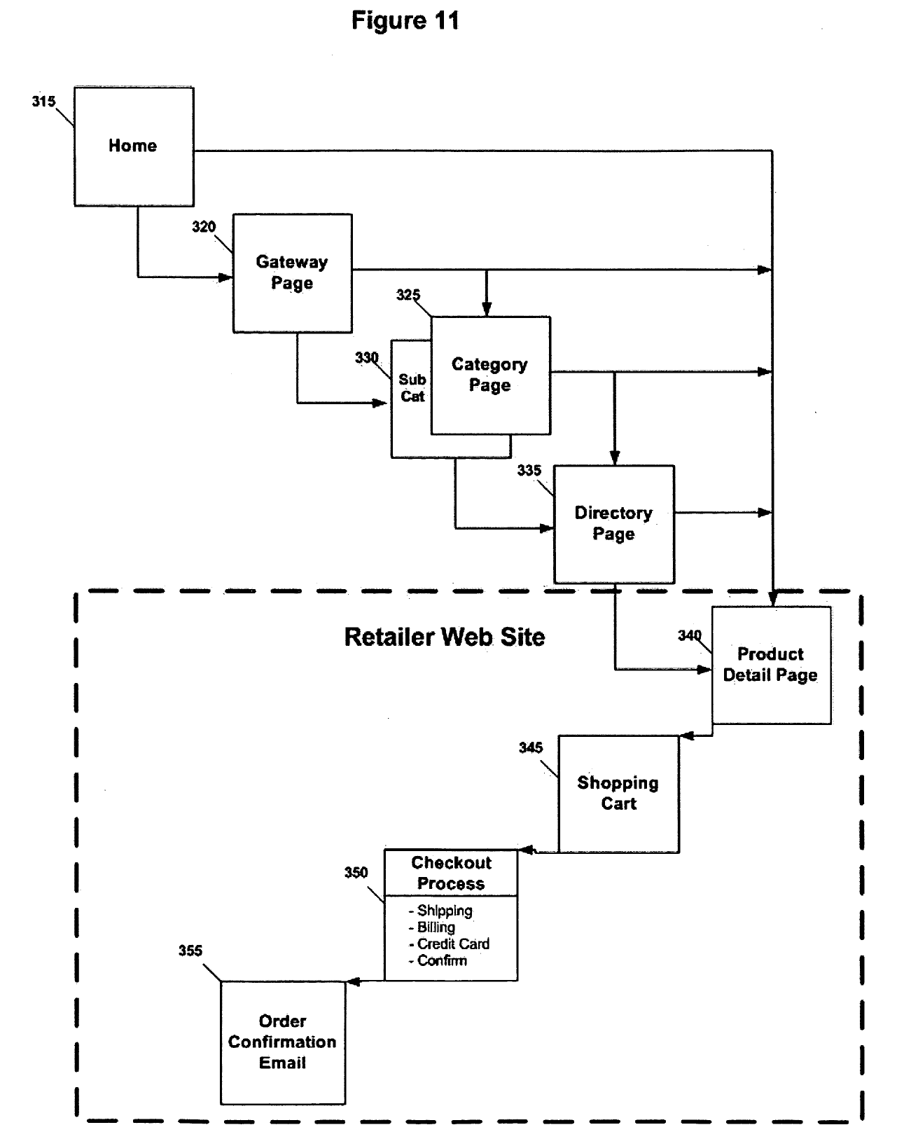

FIG. 11 is a block diagram of the page relationship of the user navigation of the present invention. Typically the user navigation begins on the Home Page 315. The home page will act as an introduction to a multitude of possible content paths, such as television shows, sporting events, and music videos.

Once a user selects a path, he or she is brought to its Gateway Page 320. The Gateway Page acts as the specific media content's introductory page providing data such as a summary to a program's next episode or biography of a musician. The Gateway Page will also contain a list of shows or events with available products.

Once the user clicks on a specific episode, music video, or event from the list on the Gateway Page the Category Page 325 is presented. The Category Page presents the user with all available product categories available on the Web Storefront, an example of a Category Page could be Women's and Men's Apparel. In some instances the Category Pages will have subsequent pages drilling down to more detailed sub-category 330, such as Women's Apparel Jackets/Coats.

Once a user has selected a product category or subcategory a product directory page is presented. The Product Directory Page 335 will present the user with all items from the specific category or subcategory. Each product displayed will contain (not limited to the following) a small image of it, a short description, price, the name of the manufacturer/retailer, selling price, and a “buy it” button.

By clicking the product's image, manufacturer/retailer's name, or the “buy it” button on the Product Directory Page, the user will be referred off the System's web storefront and on to a Product Detail Page 340 on the merchant's e-commerce site. The Product Detail Page on the merchant's site will present the user with more detailed information on the product and another link which will drop the product into the merchant's shopping cart for the completion of the purchase transaction. Once in the merchant's shopping cart 345, the user will be presented with the subsequent transaction checkout pages which will ask the user for billing and shipping information, and the user's credit card number 350. After the user has input all of the required billing and shipping information and the transaction is authorized, the user will be presented an email confirming the completion of the transaction 355. Once the transaction is complete, the manufacturer/retailer will ship the product(s) to the user.

FIGS. 12-16 are further illustrative screen mockups of a possible customer navigation path to a purchase of an item as seen on a television broadcast and as outlined in FIG. 11. In the specific illustrative embodiment of the navigation, FIG. 12 is the first step of a possible navigation path. The customer enters the System's Storefront homepage 360 and types “Friends” in the “Search for Show” search input box 361. The customer will not be limited to the “Search” input box for navigation to a program/show. For instance, a viewer will be able to navigate to a program/show by clicking the Network name and clicking on “Friends” in the online TV guide 362, and other types of navigation.

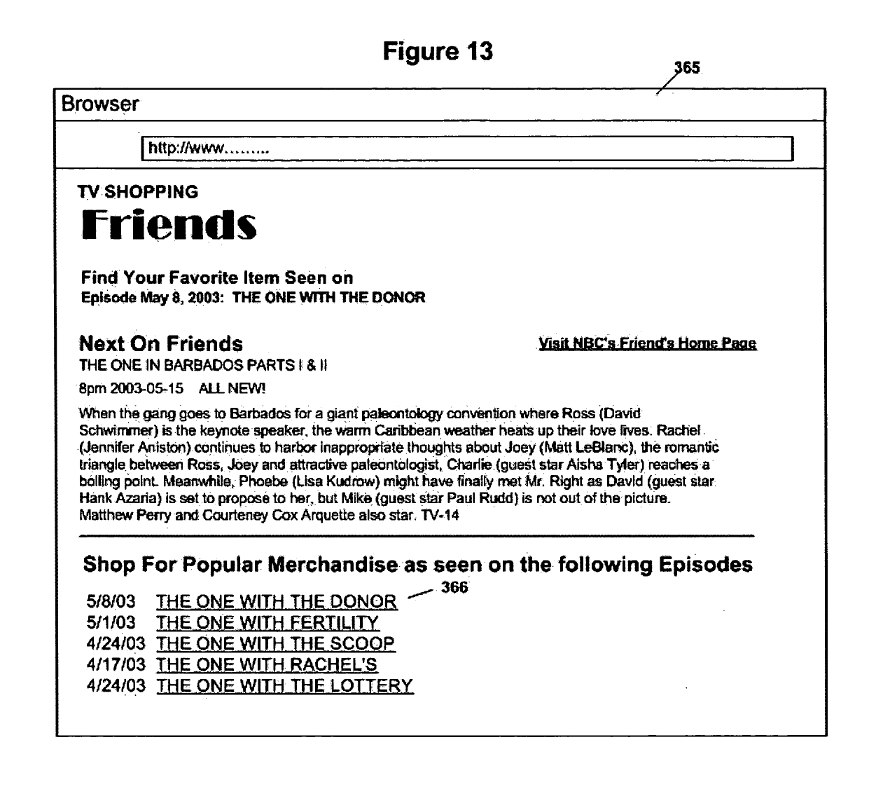

FIG. 13 is a specific embodiment of a Gateway Page 365 on the customer's step two to a purchase. From this page, the viewer will be able to read a synopsis for the next episode. The customer will be able to click through any of the last month's episodes 366 (the display of episodes will be limited to the amount of available in-stock merchandise). In the specific illustration of the Gateway Page, the customer clicks the “Friends” episode “The One With The Donor.” During off season or for shows that have gone into syndication, limited merchandise may be displayed, such as permanent set props.

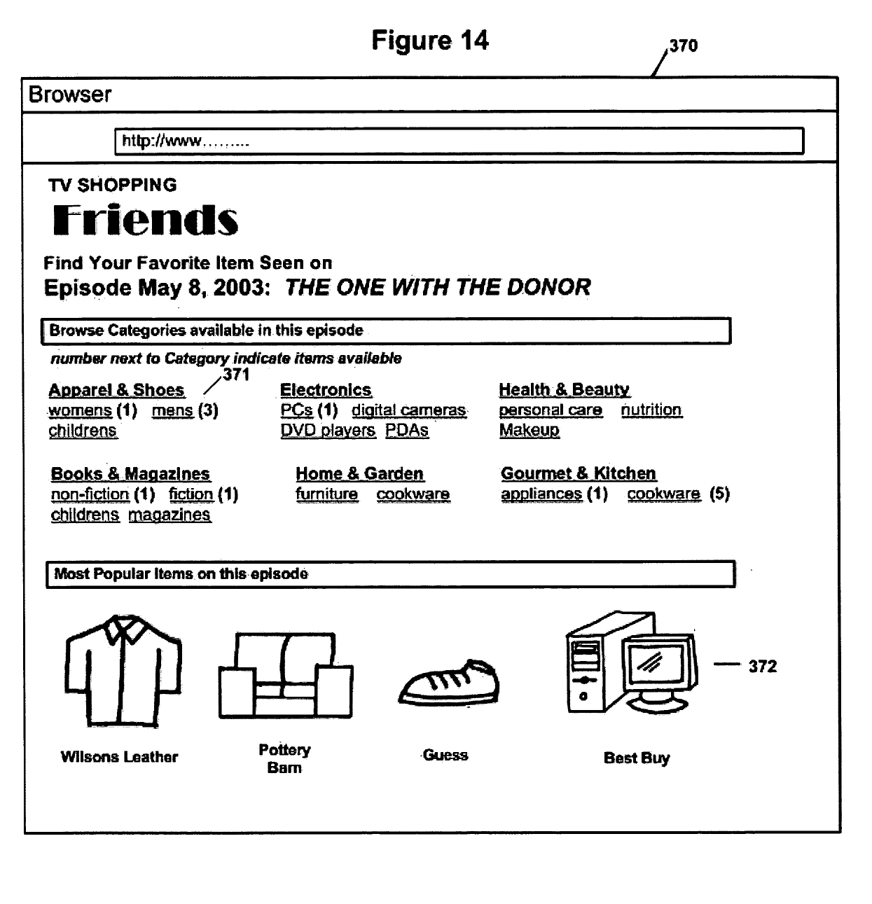

FIG. 14 is a specific embodiment of a Product Category Page 370 on the customer's step three to a purchase. After the customer has clicked the specific episode, as displayed on the Gateway Page 366 in FIG. 10, the customer is brought to the Product Category Page 370. This page will display all Available product categories. Only category names with numbers next to them will represent product categories available as displayed in the episode. The numbers will represent the number of items available in the specific category as displayed in the program's episode. For quick impulse buys, there will be product displayed on this page as “The Most Popular or Hottest Items for this Episode” 372. In the specific illustration of the Product Category Page, the customer clicks “Mens” from the category section “Apparel & Shoes” 371.

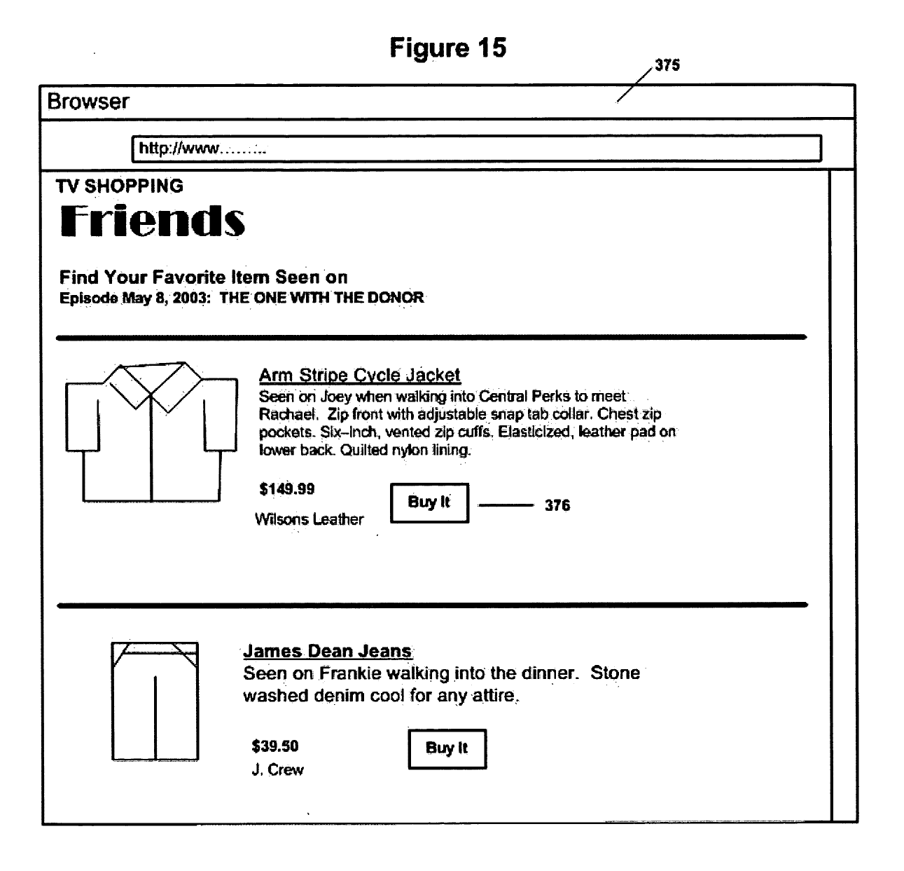

FIG. 15 is a specific embodiment of a Product Directory Page 375 on the customer's step four to a purchase. Once the customer has clicked on a specific product category (with a number displayed), the customer will be brought to the Product Directory Page 375. The Product Directory Page will contain all products within the specified Product Category displayed by a unique merchant. In the specific embodiment as displayed in FIG. 14, the customer had clicked “Apparel & Shoes/Mens”, Product Category Page (as displayed next to “Mens” under “Apparel & Shoes”, there was a number “3” representing three items available in this Category). From the Product Directory Page the user can click a “Buy It” button 376 to begin the checkout process on the Merchant's e-commerce site.

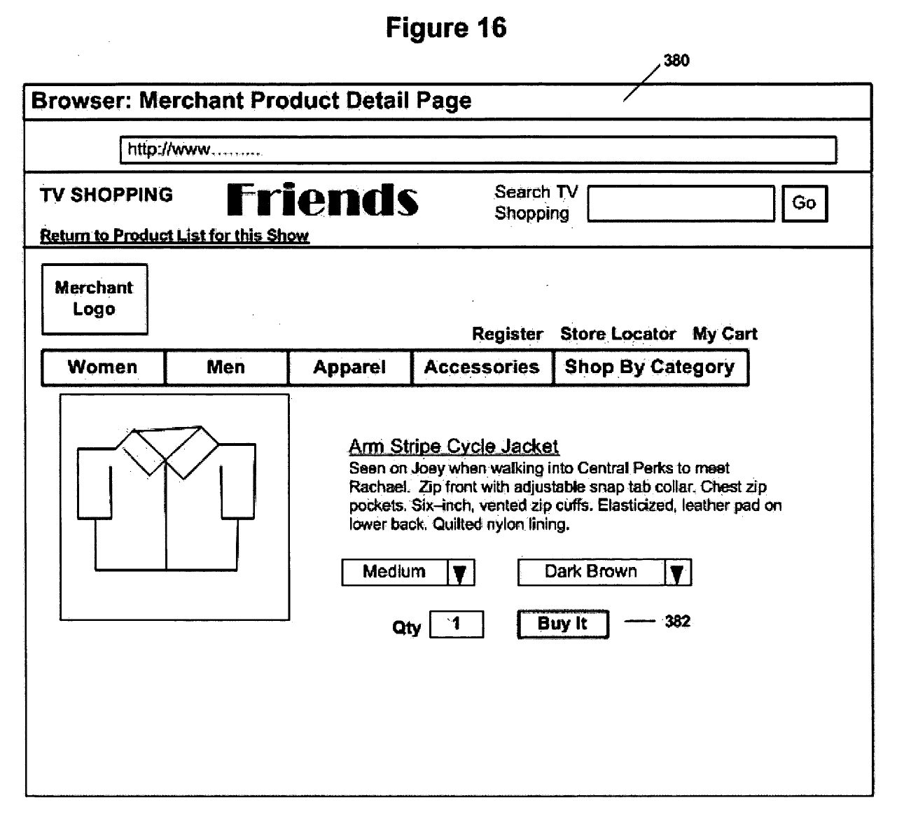

FIG. 16 is a specific embodiment of a merchant's Product Detail Page 380 on the customer's step five to a purchase. In the specific embodiment of FIG. 15 after the customer clicks the “Buy It” button (376 in FIG. 15) next to the specific item, the customer will be referred off the System's Web Storefront and onto a Product Detail Page 380 on a merchant's e-commerce website FIG. 13. Once on the merchant's site, within the same session, a logo and program frame from the System 381 will remain persistent on the top of the page for easy navigation to any of the System's web pages 360. At this point, if the viewer chooses to continue with the purchase 382, the item will be placed in the merchant's shopping cart and then through the checkout process. Once the customer has reached the merchant's Product Detail Page, the merchant will bear the responsibility around collecting shipping and billing information, credit card information, tax calculations, and shipping and tracking.

We turn now to FIG. 17, the backend logic structure of the Systems page session and general data architecture. The type of hardware and software described below is selected to conform to the data processing requirements of the System, but is otherwise a matter of choice.

A user will first access or invoke the System's Web Storefront HTML pages using an application program known as a browser 383 (the user browser represents the same as Customer 125 in FIG. 2). A popular browser is Microsoft's Internet Explorer. The user will need to locate (through a multitude of methods such Search Engines or on other web sites) or enter the System's universal resource locator (URL) address into his or her browser. A user will also be able to access the web Storefront using a wireless application protocol (WAP) browser as well. Once on the web Storefront, the user will be able to navigate, or link, from page-to-page by clicking on HTML text, which is then interpreted by the user's browser.

Part of the User's browser's 383 job will be to interpret and request applications on the System's side, also known as scripts, required to perform certain tasks on the System's web pages. A HTTP page request is invoked by the user through the browser and the processing of this request is handed off by the System's 384 web server to an executable script named “index.php” 385. The preferred web server of the System is apache 2.0. A web server's primary job is to manage the generation and presentation of web pages as requested by the user from the invention's databases. In this embodiment, index.php will herein be referred to as the “Index.” In the present invention, every web page will be created by a script utilizing a commonly used Internet development language known as hypertext preprocessor (PHP). PHP is a server side scripting language; a server side scripting language has the capability of executing a number of computational instructions on the server and returning the output of these instructions to the web server, generally in HTML format. A server side script has the main advantage of being able to interact with the databases and perform all types of server manipulations directly. The Index script then determines which page is to be loaded or invokes the correct page.

The Index's 385 main role is to act as a switch for user traffic from the web. The Index's first action is to recall the user's appropriate session object 390, if one does not exist for a particular user, a new session object is created. In Internet programming a session is defined as a data object which is persistently opened for a user between web page requests, in this example the session represents the data object that is recalled or created when a user opens a web page in the present invention. An object is defined as a collection of data that may be easily addressed and recalled, hence the session object. When a user accesses a web page in the present invention a session object will recalled or created and then based upon this session information the remainder of the System will then setup and create the correct page object 395 for the user, which in turn will create two parsers to be created and executed in series 425 and 400.

The load of a page will execute a page object 390 that loads an Extensible Markup Language (XML) file (XML is industry standard file format language commonly used to share and describe collections of data in a textual format), which is then processed by creating two parsers 425 and 400. Parsers are applications that further break up attributes or options from the page objects for other programs to manage. In the case of the present invention the parser divides up and analyzes statements in the XML. Once the XML file gives the present invention the appropriate instruction on what data is required it presents it to the user in the form of a web page.

The first of these parsers, the preprocessor in 400, invokes a generalized XML parser 405 to load in the correct page's XML 410 representation. At this stage, all XML data elements are ignored except for the processing instruction (“PI”) 415 data elements. These elements are evaluated by the PHP interpretation engine. These PI data elements are referred to as widgets 420 and each PI element may contain one or more of them. Widgets are a collection of self-describing (that is self-parsing/self-outputting) classes and represent things on the System such as login boxes, program guides and “Buy” buttons (i.e. 376 in FIG. 15 “Buy It” button on the Product Directory Page).

If the user requires HTML output to a standard web browser, the second parser in the series is the xml2HTMLparser 425 is executed. The xml2HTMLparser executes upon the successfully returned XML data from the preprocessor 400. The xml2HTMLparser first loads and parses an XSL document 430 which provides the parsing engine with the correct information to translate the XML data returned from the preprocessor 400 into HTML. In the case of the HTML output mode, the page object 395 will also specify a cascading style sheet (CSS) file 435 for the XML2HTML parser, which specifies the look and feel of the HTML 25 in the user's browser. At the top of this HTML a link is inserted to the appropriate CSS file which allows the web designer to rapidly change the style and positioning elements within the generated HTML globally and easily.

If the user requests the System's data in another formation, such as WAP, the proceeding procedure would execute but with the substitution of the xml2WAPparser. This second parser can be selected by the System, and this second parser has all of the tools it needs to transform the content specifically for the user, which makes the system adaptable to any output format.

In conclusion, the present invention's architecture is based on pages processed by the PHP server-side scripting language and defined in XML format so they may be translated to a variety of output types. The XML contains embedded PHP PI so that dynamic data can be created on the fly by self-parsing widgets. Each page request into the present invention's site is switched through the index; and each of these switched pages is translated from XML that is itself a collection of self-describing objects. This effectively breaks the system down into a collection of independent objects that can be easily maintained and extended.

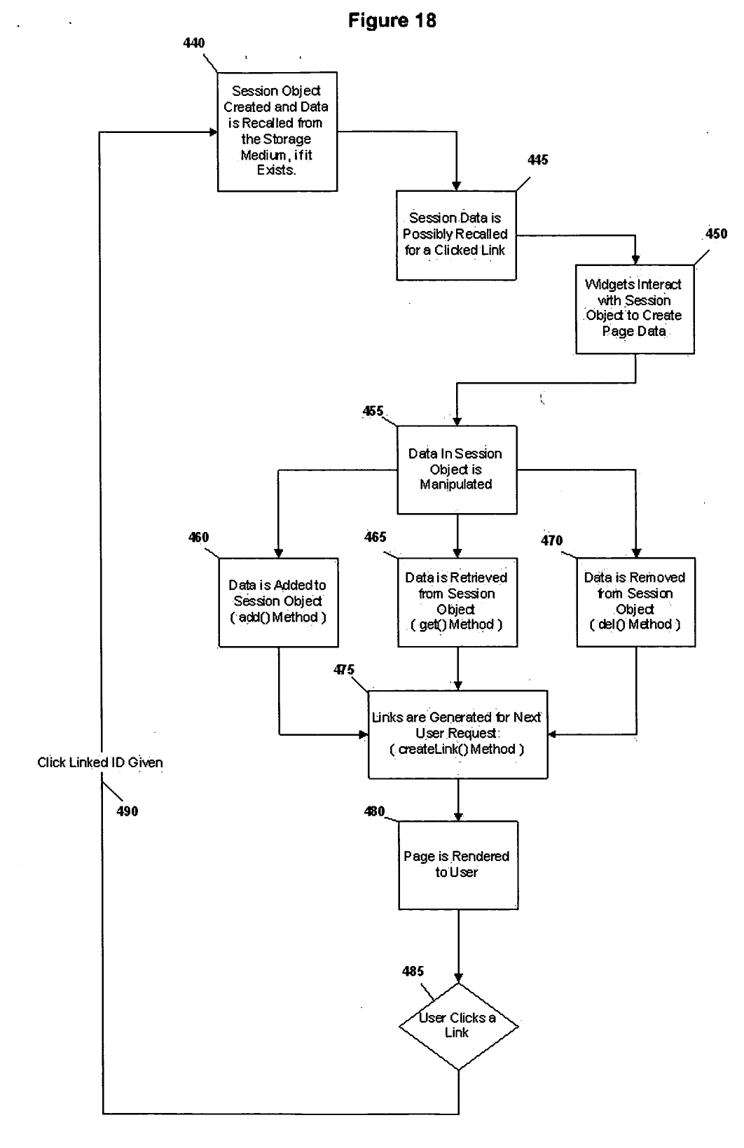

We now consider a User Session, as shown in FIG. 18. When a user invokes an HTTP page request through the browser a small text file, known as a cookie is placed on the user's computer (as long as one doesn't already exist from the System) that identifies the customer as a unique visitor to the web site and timestamps the visit. When a user is referred to the manufacturer/retailer's Product Detail Page the present invention's cookie will uniquely track the user's click to the manufacturer/retailer and the completion of a sales transaction on its web storefront.

In cases where a user is referred to a manufacturer/retailer's Product Detail or other Page, the Index will launch a session object 440 which then creates a page object. The specified page object executed in this instance, will draw a page. The Index determines the appropriate page. The Index parsers identification codes unique to a manufacturer/retailer from URLs embedded in page elements such as “Buy It” buttons or advertisement banners (in the form of commonly used Internet graphic formats such as GIF or JPEG). An example of a URL appended with a code is as follows:

www.mycompany.com/index.php?id=2000

The page drawn will contain a banner at the top containing navigational elements (i.e. navigating to other sections of the System's Web Storefront). In this page drawn by the page object, it will also embed HTML elements from the manufacturer/retailer's web site (i.e. product images, product descriptions, company logos, etc.).

The session object's primary role in the system is to store data in between user page requests (insert cross reference here). It is by means of being able to recall this data across requests that the user can be given the contiguous experience of moving through the system, click-by-click.

When a user visits the system for the first time, a session object is created 440. As no session data previously existed for this user, the object will be empty and 445 will execute without recalling anything. Widgets 450, such as the page widget (insert cross reference) with access the session object and manipulate data within the user's session 455 by means of adding 460, retrieving 465, or deleting 470 data items.

These data items stored in the session object can be anything that needs only to be stored between pages accesses. Data that needs to be permanently stored for a user, such as user login information, is stored in the database. Data stored in the session object is most importantly defined as being data that the widgets use to react to user requests.

Hyperlinks for new pages requests are created by widgets interacting with the session object by calling the createLinko interface 475. When the page is rendered to the user in 480, link ID 490 numbers are generated from the createLinko interface 475 are given to the next page request when the user actually clicks a link from within their web browser.

From this user click, the session object is recreated by a new instance of the system 440. Specific data tied to the link clicked is recalled in 445. The rest of system continues to execute, thus creating a coherent user experience.

In the second component the Digital Television Interface, referring back to FIG. 1 of the present invention, products 50 chosen by a television or media content provider are placed in a specific televised program to be filmed 60, identified, and later synchronized with recorded/filmed scene footage. As discussed in the Web Storefront Interface, the product first must be loaded to the Master Media Content Database (MMCD) from the respective Merchant Product File (MPF).

The first objective of the Digital Television Interface is to setup the products placed in the program so that they can be synchronized with the recorded footage of each scene.

The second objective of the Digital Television Interface is to track objects in the frame of view that are in motion or still, such as actors or automobiles by establishing its three dimensional position or x,y,z coordinates and projecting these positions into a two-dimensional presentation or x,y coordinates to be viewed on a television screen.

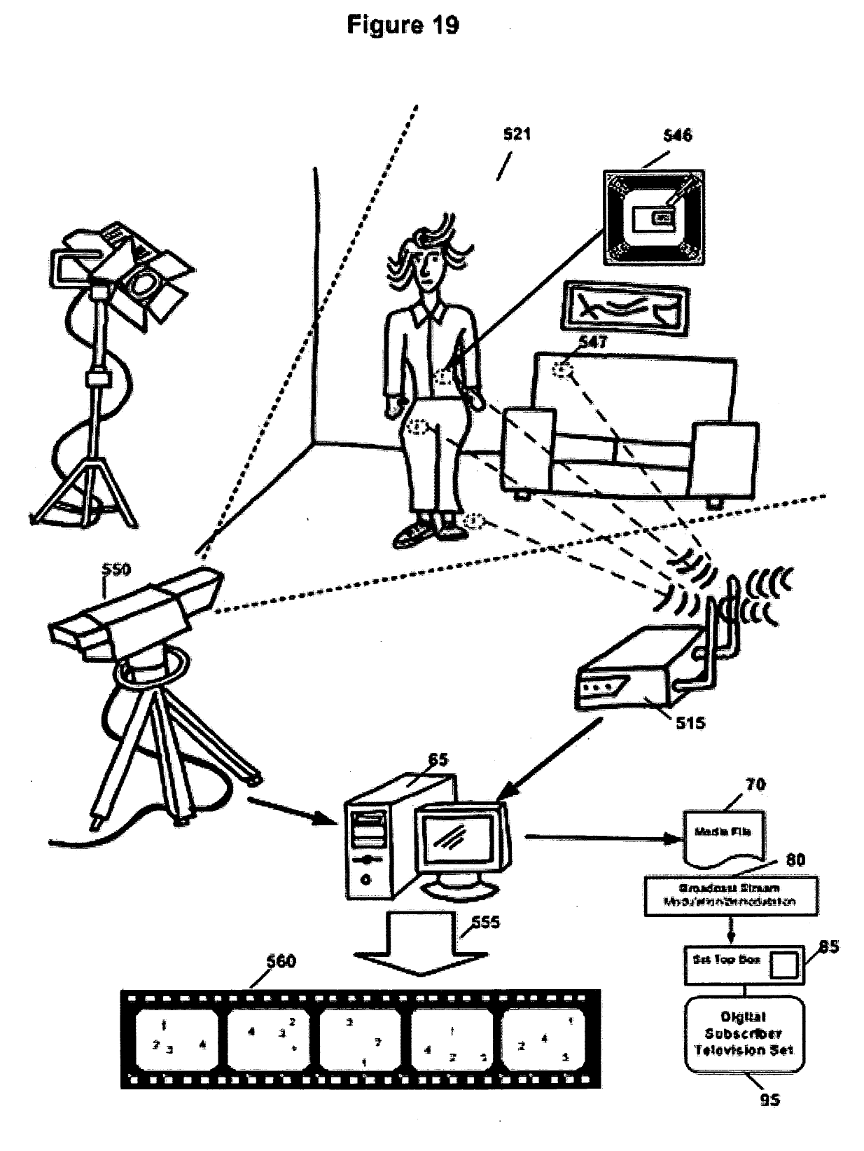

Turning now to FIG. 19, to the detailed embodiments of the first objective of setting up products to be synchronized with frames filmed of each scene on the production set 521. During a televised broadcast (live or taped) multiple cameras 550 are used to capture footage, which is later assemble/edited into a complete program. While the program footage is being captured it is passed frame-by-frame, either by coaxial cable or radio frequency, in a digital format to a computer, herein to be known as the Media Server 65. At the same time footage is being captured by the cameras, selected placed products 545 will be identified using a commonly known methodology Radio Frequency Identification (RFID) tagging 546. In order for products to be electronically identified, RFID tags are wirelessly placed on the products 546. Unique product data and location information are digitally captured using an RFID reader 515.

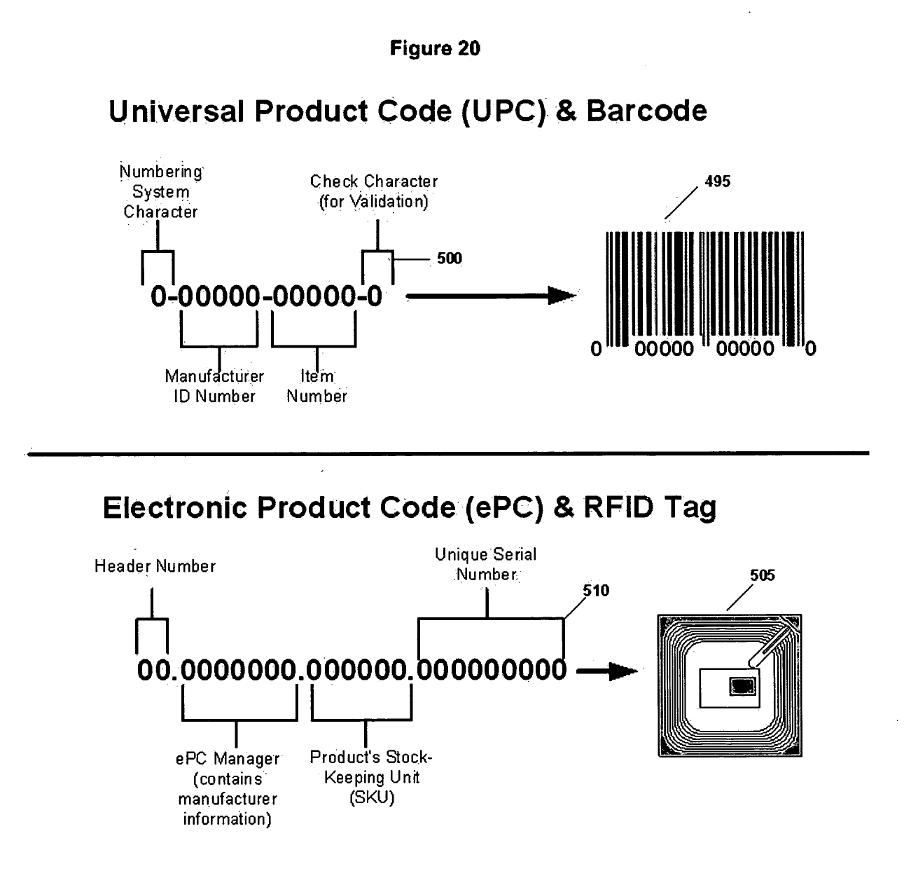

RFID technology utilizes a methodology of transmitting data wirelessly. An RFID system comprises of a reader 515 and a tag 546 that can be either active (powered by a battery) or passive (no power source required). The preferred tag of the present invention utilizes a passive tag. The reader (also known as the interrogator) generates an alternating magnetic field that powers all passive tags up to a 300-foot radius. Once the passive tag is powered it acts as a transponder by modulating the magnetic field from the reader and transmits data back to the reader 515. The transmitting of data from the RFID tag to the reader will herein be referred to as the “signal.” Once the reader receives the data from the RFID tag's signal, it passes it to the Media Server 65 to be processed. The tag's signal passes uniquely programmed data with a capacity up to 128 bits (FIG. 20 shows how product data stored on an RFID tag differs from traditional UPC barcodes).

Another objective of the RFID tag's signal is to track objects in the camera's frame of view that are in motion or stationary by establishing a three-dimensional local position, or its x,y,z coordinates and then projecting it them into x,y coordinates to be passed in the Media File 65. Establishing an x,y,z coordinate system will occur by triangulating the signals from each RFID tag 546. Triangulating RFID signals are made possible by commercially available RFID readers, such as Pinpoint Co. i-Port III, which houses four internal antennae required to triangulate based on time-of-flight calculations. Once the reader captures the RFID data, it decodes it and passes it to the media server 65 to process two-dimensional x and y coordinates. The x and y coordinates will be used to map out the exact location of the objects in relation to what the camera is capturing frame-by-frame. From this map the media server will then superimpose the locations of the objects into the video images frame-by-frame captured by the cameras. Once the locations are superimposed into the video images, small electronic markers 547 (either gifs or jpegs) will be generated and track with each of the objects (identifiable to the television viewer).

Turning now to the creation of the Media File 70 that synchronizes RFID tag data captured by the reader 515 to video/film frames captured by the cameras 550. The synchronization 555 is made possible by using SMPTE (Society of Motion Picture and Television Engineers) time code, which is commonly used in digital video to place parallel video and audio tracks on a standard time line. SMPTE time code follows a format as follows, 00:00:00:00 (hour:minutes:seconds:frames). SMPTE time code can run at five different running modes from running off a clock's standard time of day, whether or not video images are being captured, to a time code which does not correlate to the actual time of day.

Since product data and location information will be redundantly passed due to the frame-by-frame capture 560, the Media Server will dedupe (term used in computer programming to consolidate redundant data) the instances and break them out by time segments (segments in which they are viewable to the television viewer). For instance, in a particular scene, lasting two minutes, a character may be wearing a pair of jeans with an RFID tag place on them. Over a period of two minutes of recording footage 3600 frames will be captured by the camera, hence containing 3600 instances of ePC 123 will be passed to the media server. The media server will dedupe this so that only one reference of ePC 123 is logged for the two-minute frame segment.

Once the object's RFID data and video/film frame data is synchronized in the Media File, it will be passed to a digital cable/satellite company multiplexer to be placed into the broadcast stream 80 which reaches digital network subscribers' set-top boxes 85, which connect to television sets 95 for viewing. The digital broadcaster's multiplexers primary functionality is to broadcast video, audio, and other types of data to individual households subscribing to a digital network.

FIG. 20 details how the product data can be stored on the RFID tag 505 as an Electronic Product Code (ePC) 510 matching up with product data stored in the MMCD. Unlike the traditionally used UPC in barcodes 495 that limited to registering the product's make or model 500, an ePC assigns a number to each individual item. The unique number acts as a reference to the specific product stock-keeping unit (SKU). The location data identifies the product's location in any given frame. Both the product data and location information are passed to a Media Server where they are synchronized in with the recorded footage of the television show. The synchronization of both of these elements will be passed as a file, known as the Media File, to the cable or satellite company for broadcast to subscriber television sets.

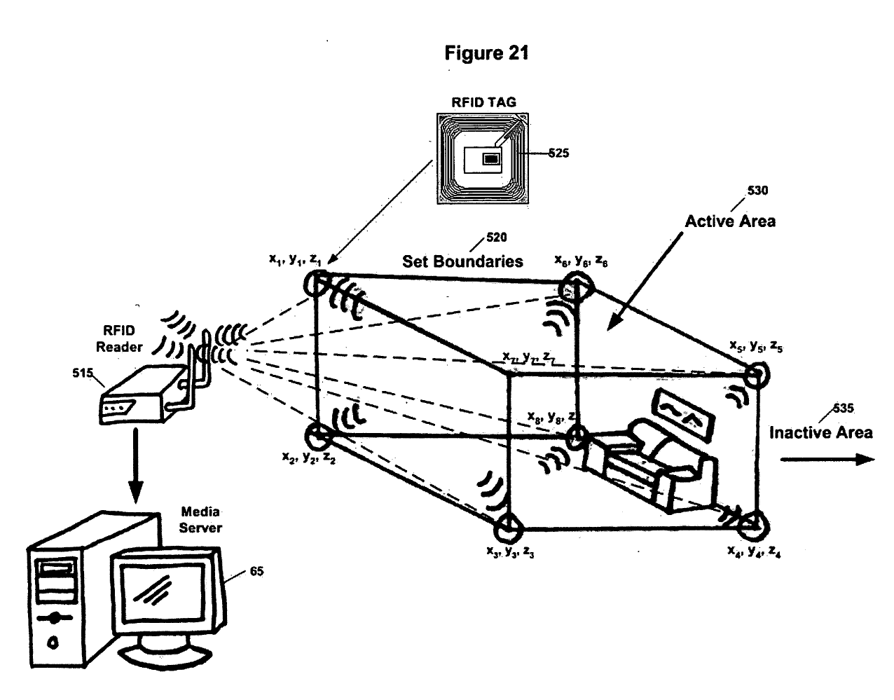

FIG. 21 illustrates how the present invention utilizes a unique process, which establishes the boundaries 520 within a production set so that RFID tags can be activated and deactivated. It is important to note that a RFID reader 515 will indiscriminately capture signals from all RFID tags within a 300 foot radius. Hence it will be required that only RFID tags that are in the camera's frame of view be active. Therefore the present invention utilizes a systematic method of establishing boundaries 520 for activating and deactivating RFID tags. The boundaries of any given shot or scene being filmed will first be marked by RFID tags 525. A software application will create the boundaries based on the triangulation of the marker RFID tags 525. If a RFID tag is introduced into a shot (such as a character walking into the camera's frame of view) or already exists in the shot the software application will activate 530 the RFID tag which has been placed on the product the character is wearing (i.e. shirt, pants, shoes, etc.) Once the character leaves the camera's frame of view (established boundary), the RFID tag is deactivated 535. Hence only activated RFID tags will be associated with the footage being recorded at the same time.

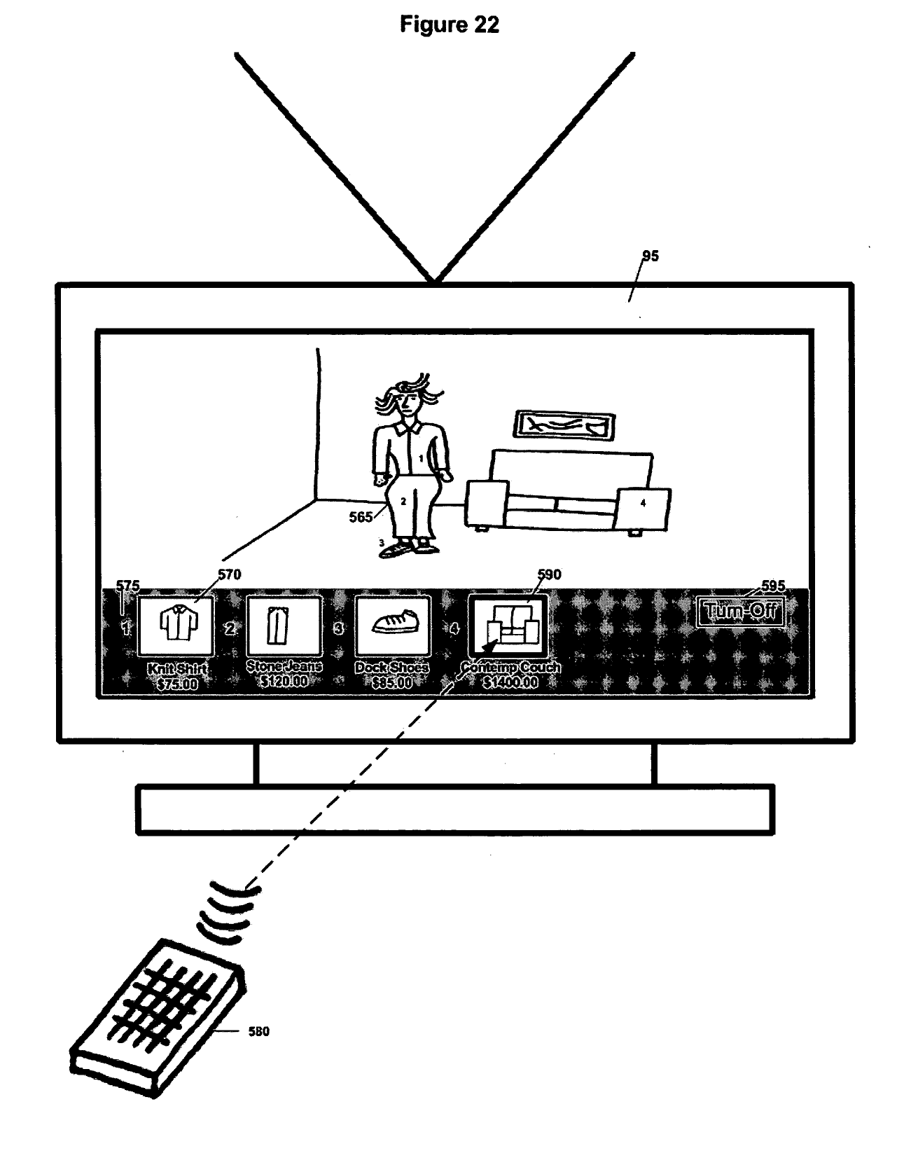

FIG. 22 illustrates how data from the Media File may be displayed on the digital subscriber's television set. In the embodiment of the present invention the System's Media File is passed across the digital network. An industry standard known as Advanced Television Enhancement Forum (ATVEF) allows web-based content to be included in the digital broadcast stream and display on digital subscriber's television sets. Subscribers of digital broadcast networks are able to accept video, audio, and other types of data through a device, known as a “set-top box” (employing ATVEF), which is connected to their television set. The set-top box acts as a data processor, very similar to a personal computer (PC). Like a PC, a set-top box is able to process a multitude of digital files that have been programmed using the same API. An example of a commonly used set-top box is Scientific-Atlantic's Explorer. The set-top box also has data storage in the form of both random access memory (RAM) and dynamic random access memory (DRAM). Furthermore, set-top boxes employing ATVEF give the individual digital subscriber the ability to transfer data through a back channel to the Internet via a dial-up modem, cable modem, or any other type of bidirectional access channel. A back channel is required for a subscriber to have any type of interaction with content streamed to the set-top box. As discussed below, the present invention employs the use of a back channel to communicate with the System.

The Media File containing the product data and location information is only broadcast to an individual subscriber's set-top box if requested by the subscriber. Pushing a button on his or her television remote 580 or selecting a button 595 (“on” or “off” button) displayed on his or her television set. The Media File can reside at either the digital network provider or other location tied to a server on the Internet. When the Media File is broadcast to a subscriber, it is then stored in the local memory of the subscribers set-top box. The Media File will then synchronize with the time coded references of the television program. Since the Media File is stored on set-top boxes' local memory, it will be able to utilize the local bus of the set-top box. Being able to utilize the local bus and memory of the subscriber's set-top box will transfer the data processing load off the digital broadcast network. The digital broadcast network processes data at a much slower rate than the local bus of an individual subscriber's set-top box because of the magnitude of processes required to broadcast to the entire network of sometimes millions of subscribers.

The synchronization process on the set-top boxes' local bus of the Media File and the time coded video and audio data from the digital network's multiplexer will enable a real-time display of both the graphic product markers 565 superimposed on objects as they appear in the scene and small interactive 585 (using the remote to select) thumbnail images 590 of the objects appearing across the bottom of the television viewing area. The user will be able to turn this feature on and off, so that it does not distract the viewing of the program.

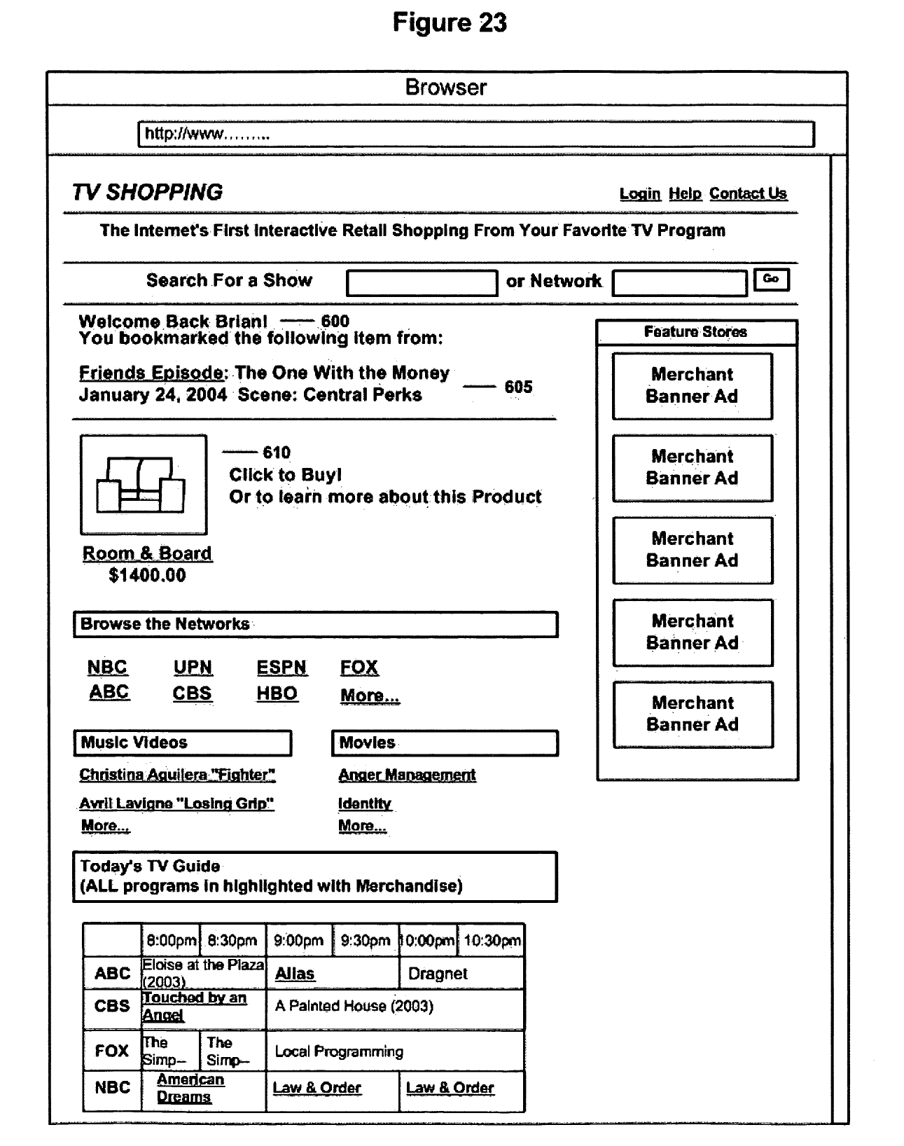

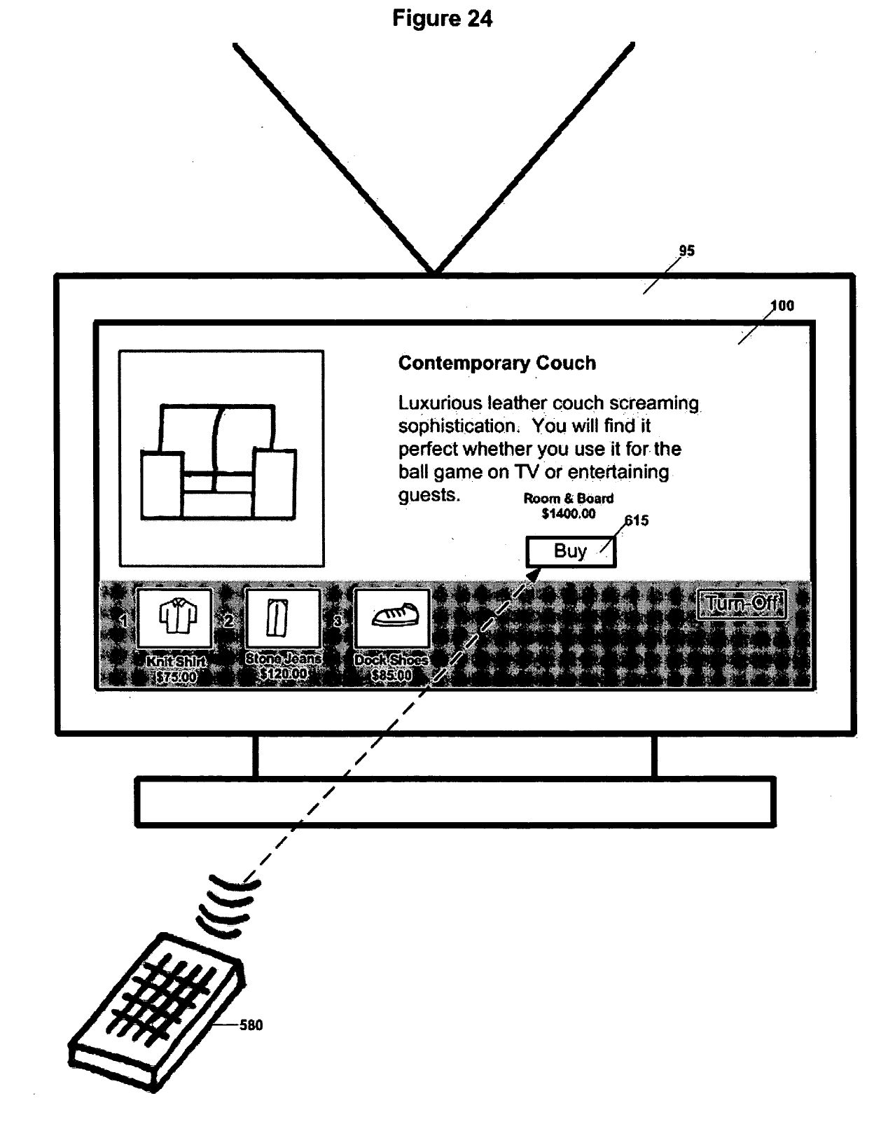

FIGS. 23 and 24 illustrate the interactivity possibilities of the marked objects in any given scene. In an embodiment of the present invention the small product images appearing across the bottom of the television viewing area will be interactively selectable. Product images can be selected using the television's remote control. By selecting a product image either the selected item will be book marked FIG. 24 and presented on the System's Web Storefront when the user visits the web storefront next or a pop-up window FIG. 24 will appear where a subscriber will be able to directly purchase the item.

FIG. 23 describes the book marking process in more detail. In the preferred embodiment of the present invention, by selecting the product image a small data file including, but not limited to, the product's SKU or Style number, time of selection, television program, a set-top identification code uniquely tying the subscriber to the selection, and episode information is sent back through the set-top box to the digital network which will maintain a connection to the Internet. The file passes across the Internet to the System where a record will be logged/bookmarked for a subscriber to later visit the System's web site to process a sales transaction of the item selected from the television program. When the user returns to the Web Storefront home page, a personalized greeting appears 600 (made possible as explained in FIG. 18 User Session). In conjunction with the personalized message, detail on the specific program 605 and the product 610 that the user selected on the television is also displayed. Clicking on the product takes the user to the Product Directory Page (as illustrated in FIG. 15) where he or she can link to the merchant's e-commerce site to purchase the item.

FIG. 24 describes the pop-up purchase window display. After selecting the small product image appearing across the bottom of the television viewing area, a window 100 will appear with more product information. Furthermore, from this window the user can select a “buy” button 615 with the remote 580, which invokes a call to another interactive page to the merchant's checkout process page.

The description of the invention and its applications as set forth herein is illustrative and is not intended to limit the scope of the invention. Variations and modifications of the embodiments disclosed herein are possible, and practical alternatives to and equivalents of the various elements of the embodiments would be understood to those of ordinary skill in the art upon study of this patent document. These and other variations and modifications of the embodiments disclosed herein may be made without departing from the scope and spirit of the invention.

U.S. Patent Documents

| | | |
|---|---|---|
| 4,064,528 | December, 1977 | Bowerman |
| 5,818,441 | October, 1998 | Throckmorton, et al |
| 5,991,735 | November, 1999 | Gerace |
| 5,991,740 | November, 1999 | Messer |
| 6,029,141 | February, 2000 | Bezos, et al. |
| 6,100,925 | August, 2000 | Rosser, et al. |
| 6,249,914 | June, 2001 | Harrison, et al. |
| 6,275,989 | August, 2001 | Broadwin, et al. |
| 6,499,052 | December, 2002 | Hoang, et al. |
| 6,539,545 | March, 2003 | Dureau, et al. |
| 6,574,793 | June, 2003 | Ngo, et al. |
| 6,597,406 | July, 2003 | Gloudemans, et al |
| 6,606,746 | August, 2003 | Zdepski, et al. |

### OTHER REFERENCES

“Electronic Product Code”, Eileen Mullin, Baseline September 2002
“A Technical Description of SMPTE/EBU Timecode,” Phil Rees Music Tech, UK “STATE OF THE ART; For TiVo And Replay, New Reach”, David Pogue, NYT May 29, 2003.
“Time Warner to Test Microsoft's iTV Software”, Erin Joyce, Internet News Jul. 21, 2003
“TV Sports Score With Tech”, Jim Goldman, techTV Apr. 17, 2002
“Cruising the Online Mall”, MARYANNE MURRAY BUECHNER, Time Magazine Mar. 2, 2003
“Sony, Phillips Partner on RFID tech for m-commerce”, Bob Brewin, ComputerWorld Sep. 6, 2002
Steinhorn, Jason and Mark Kohler. “Enhancing TV With ATVEF” Embedded Systems Programming, October 1999, pp. 55-64.
2002 Nielson Rating Report
“Visual Sensing Middleware Support for Sentient Computing”, Diego López de Ipiña González de Artaza, Downing College University of Cambridge, January 2002. Dissertation.
“RFID A Key to Automating Everything”, Roy Want, Scientific American, January
“Enhanced Construction Object Recognition Through Sensor Fusion”, William C. Stone, Building and Fire Research Laboratory.

1: A method of maintaining a media database, comprising the steps:
selecting a plurality of video programs designated by a content provider as having products placed therein for possible purchase;
selecting a subset of such products from the group of placed products associated with the selected programs;
creating a database of the product subset;
associating the product subset with product description information;
associating the product subset with product purchase information;
generating a web page on the internet accessible by a user that associates the product subset with a product merchant; and
allowing the user to select a video program by name and view the product subset for the program so that a user may easily locate and purchase products shown on the selected program.

2: The method of claim 1, wherein a user may access the web page and select a specific program from the plurality of video programs, and further comprising:
performing a search of available products associated with the specific program;
allowing the user to choose a particular product from those identified by the search; and
processing orders of such products by the user.

3: The method of claim 1, wherein a user may access the web page and select a specific video program from the plurality of programs, and further comprising:
performing a search of available products associated with the specific episode;
allowing the user to choose a particular product from those identified by the search; and
processing orders of such products by the user.

4: The method of claim 3, further comprising:
creating a database of products selected for possible later purchase by users; and
providing a report based on website statistics and revenue for the merchant.

5: The method of claim 4, further comprising:
creating a website;
linking products to a source;
forwarding the purchase request to a vendor of the product and completing a sale; and
receiving a fee from the vendor.

6: The method of claim 5, wherein the database of placed products correlates the product to a product field of description, SKU, category, episode, program title, product title, retailer, manufacturer, artist, album, director, actor, music genre, content genre, song title, country of origin, date and content provider, so that the user may search by product field to find the placed product.

7: The method of claim 6, wherein the transaction is completed from the vendor's website.

8: A method of dynamically identifying the location of a purchasable object in a field of a video program, comprising:
creating a database of products placed in the video field;
providing a video signal, wherein the video signal displays the object on screen for a length of time;
generating dynamic position information in response to the location of the object on screen;
synchronizing the dynamic position information to the video signal to form a linkable data annotation to the video signal which identifies the product and its variable location on the screen; and
transmitting the annotated data and video signal to viewers.

9: The method of claim 8, wherein the dynamic position information is calculated from a camera location, a camera angle and a location signal, the location signal corresponding to an on-screen location of the object.

10: The method of claim 9, wherein the location signal is generated by local positioning time-of-flight calculations.

11: The method of claim 10, wherein the location signal is generated by an RFID reader, and wherein the object is identified by an RFID tag.

12: The method of claim 11, further comprising:
using a plurality of boundary RFID tags that define a periphery of an active region, wherein the object is tracked only while it is inside the active region.

13: The method of claim 12, further comprising:
identifying the object with an icon at the edge of the screen during the length of time in which the object is tracked.

14: The method of claim 13, further comprising:
identifying the object with an icon at the bottom of the screen during the length of time in which the object is tracked.

15: The method of claim 12, further comprising:
identifying the object with an icon in proximity to the object on the screen during the length of time in which the object is tracked.

16: A method of purchasing an object, comprising:
selecting an object for purchase;
establishing a plurality of boundary RFID tags to define the periphery of an active region;
placing an RFID tag on the object, each tag capable of having a unique identifier;
using an RFID reader to determine the locations of the object and the boundary RFID tags;
tracking the location of the object while it is inside the active region to establish a location signal with location information encoded therein;
calculating a two-dimensional position signal, the position signal corresponding to the location of the object in the video frame;
synchronizing a video signal recorded by the video camera to the two-dimensional position signal to form an annotated video signal;
transmitting the annotated video signal to a user terminal;
establishing a media database having product data linked to specified identifiers;
performing a query from the user terminal to the media database to retrieve information about the object, the information including a representative icon and a web link to a vendor that sells the object;
displaying an icon corresponding to the object at the edge of the screen during the length of time in which the object is tracked within the active region; and
providing means for the user to select at least one icon and transmitting such selection to a second database of items selected for purchase for review.

17: The method of claim 16, wherein the location signal contains location information in three dimensions.

18: The method of claim 17, further comprising:
recording the position and orientation of a video camera that records activity within the active region; and
using the three-dimensional location signal, the recorded camera position and the recorded camera orientation to calculate the two-dimensional position signal.

19: The method of claim 16, further comprising:
providing an onscreen listing of such selected items and allowing the user to purchase such items.

20: The method of claim 16, further comprising:
transmitting the list of such selected items to a specified web page accessible to the user and allowing the user to access the page and purchase said selected items.

21: A method of identifying an object featured on a set of a pre-recorded television program, comprising:
establishing a plurality of beacon RFID tags;
placing the plurality of beacon RFID tags at a plurality of substantially stationary beacon locations on the set of the television program, prior to recording of the program;
establishing at least one object RFID tag;
attaching the at least one object RFID tag to the object;
placing the object on the set of the television program during recording of the program;
using an RFID reader to record the relative locations of the plurality of the beacon RFID tags and the at least one object RFID tag, so that any movement of the object within the set during recording of the television program may be tracked;
establishing a time code representing a time index of the recording;
synchronizing the recorded location of the at least one object RFID tag with the time code;
generating a media file representing the combination of the at least one RFID tag location with respect to the time code;
downloading the media file to a set top box;
processing the media file with the set top box, so that when the television program is transmitted to the set top box, the set top box displays an icon on the screen whenever the object appears in the video frame.

22: The method of claim 21, wherein the media file is downloaded separately from the television program.

23: The method of claim 22, wherein the media file is downloaded prior to the television program.

24: The method of claim 21, wherein the time code is SMPTE.

25: A method of processing a media file containing object location information synchronized with a time code, comprising:
receiving the media file by a set top box;
selecting an icon corresponding to a product displayed on the screen by the set top box; and
bookmarking the product, the bookmarking comprising:
generating an identification file containing viewer information, program information and information about the selected product;
sending the identification file to a central system, the central system having an accessible website;
accessing the website of the central system; and
receiving a personalized message on the website, the personalized message having the information contained in the identification file including the viewer information, the program information and information about the selected product.

26: A method of processing a media file containing object location information synchronized with a time code, comprising:
receiving the media file by a set top box;
selecting an icon corresponding to a product displayed on the screen by the set top box during the viewing of a video program; and
purchasing the product, the purchasing comprising:
entering payment and shipment information into an interface screen delivered through the set top box.

27: The method of claim 26, further comprising:
pausing the play of the video program before the purchasing step; and
resuming the play of the video program after the purchasing step; wherein
the pausing and the resuming occur at substantially the same point in the video program.

28: The method of claim 26, wherein the set top box uses the Advanced Television Enhancement Forum as its television application interface.

29: A system for purchasing a product featured on a video program, comprising:
a plurality of video programs, each video program having a video field;
a plurality of products for purchase, each product being linked to at least one program, the products being displayed for at least some time in the video field, each link also connecting a product to a source of supply for purchase;
a searchable database comprising a plurality of said links;
an encoder which tracks the dynamic location of a product in the video field to establish a two dimensional location signal, and which synchronizes the two-dimensional location signal to the database to form product tracking information;
a transmitter which transmits both the video program simultaneous with the product tracking information to the customer;
a decoder which receives the transmitted video program and the product tracking information, the decoder displaying the video program on a television and displaying indicia corresponding to the product displayed on the television during the duration of time that the product appears in the video field; and
a user-selectable controller which allows the user to select specific indicia corresponding to products that the user may wish to purchase.

30: The system of claim 29, further comprising:
a plurality of beacons which establish a periphery of an active region;
a calculator which detects when the product is located within the active region, and produces the two-dimensional location signal when the product is within the active region.

31: The system of claim 30, wherein the plurality of beacons are RFID tags, and the calculator comprising an RFID receiver.

32: The system of claim 31, wherein the tracked dynamic location includes location information in three dimensions.

33: The system of claim 32, wherein the calculator records the position and orientation of a video camera that records activity within the active region and uses the three-dimensional tracked dynamic location, the recorded camera position and the recorded camera orientation to calculate the two-dimensional position signal.

34: The system of claim 31, wherein the tracked dynamic location includes location information in only two dimensions.

35: The system of claim 34, wherein the calculator uses the two-dimensional tracked dynamic location to calculate the two-dimensional position signal.

36: The system of claim 29, further comprising:
a second database of selected indicia; and
a user-selectable output on said television capable of displaying the contents of said second database so that the user may investigate or purchase items from said second database.

37: The system of claim 29, further comprising:
a second database of selected indicia; and
a user-selectable output on a web page capable of displaying the contents of said second database so that the user may investigate or purchase items from said second database.

38: The system of claim 29, wherein the encoder tracks the location of a product in the video field manually.
